(19) United States
(12) Patent Application Publication
(10) Pub. No.: US 2020/0367493 A1
(43) Pub. Date: Nov. 26, 2020

(54) BIOCONTROL ENHANCERS

(71) Applicant: YEDA RESEARCH AND DEVELOPMENT CO. LTD., Rehovot (IL)

(72) Inventors: Ilana KOLODKIN-GAL, Rehovot (IL); Asaph AHARONI, Rehovot (IL)

(73) Assignee: YEDA RESEARCH AND DEVELOPMENT CO. LTD., Rehovot (IL)

(21) Appl. No.: 16/323,787

(22) PCT Filed: Jun. 6, 2017
(86) PCT No.: PCT/IL2017/050633

§ 371 Date: Feb. 7, 2019

(30) Foreign Application Priority Data
Aug. 8, 2016 (IL) 247169

(51) Int. Cl. A01N 43/16; A01N 43/12

(52) U.S. Cl. CPC A01N 43/16; A01N 43/12

(57) ABSTRACT

The present invention relates to the identification and use of natural plant compounds for inducing, enhancing and maintaining beneficial rhizobacteria biofilm formation on a plant or plant part thereof, and conversely, inhibiting formation of biofilms and pellicle by plant pathogens. Methods of use for stimulating matrix production from the beneficial rhizobacteria and enhanced adhesion of the rhizobacteria to a plant or plant part thereof are also described. Methods of use for inhibition plant pathogen adhesion to biofilms are also described.

### FIELD OF THE DISCLOSURE

Identification and use of natural plant compounds for inducing and enhancing beneficial rhizobacteria biofilm formation is disclosed, as is the identification and use of natural plant compounds for inhibition of biofilm and pellicle formation. Methods of use of natural plant compounds for stimulating matrix production from the beneficial rhizobacteria are also disclosed.

### BACKGROUND

Despite the widely held view of bacteria as primitive, unicellular organisms that struggle for individual survival in nature, bacteria establish complex communities, referred to as biofilms that are stimulated by chemical communication. A biofilm can be viewed as a differentiated community, where the inhabitant cells are held together by an extracellular matrix. While they can be formed by most, if not all pathogens, biofilms may also be formed by beneficial bacteria. A key-example of beneficial bacteria is the motile Gram-positive, catalase-positive bacteria, Bacillus subtilis (B. subtilis), which is found in soil and the gastrointestinal tract of ruminants and humans. B. subtilis organize themselves into conspicuous multicellular structures that carry out specialized tasks. These orchestrated processes are tightly regulated by multiple forms of cell-cell communication.

Bacterial biofilms are ubiquitous and are of high significance in agricultural, industrial, environmental, and clinical settings. In many instances, they provide beneficial effects to other organisms, as is the case of B. subtilis biofilms that form on the surface of plant roots, thereby preventing the growth of fungal pathogens. Studying the factors that regulate the formation and disassembly of biofilms on top of the root is therefore of great interest from scientific, as well as ecological, and agricultural perspectives.

B. subtilis is a genetically manipulable model organism that can differentiate into a remarkably large number of distinct cell types, including motile cells, rafts of swarmer cells, genetically competent cells, matrix-producing cells, and sporulation cells. The complicated network regulating biofilm formation in B. subtilis is well studied. The main components of the B. subtilis extracellular matrix are exopolysaccharides, synthesized by the epsA-O operon-encoded genes, and TasA, a functional amyloid, encoded in the three-gene operon yqxM/tapA-sipW-tasA. The master regulator controlling the switch to a biofilm lifestyle is the repressor SinR. In standard laboratory settings, several cues have been associated with biofilm maturation and assembly, including oxygen deprivation, nutrient deprivation, small molecule sensing and physical cues.

Research has primarily focused on intrinsic triggers, resulting from increased cell density or starvation. To date, very little research has focused on an assessment of genetic pathways of biofilm maintenance over the eukaryotic host.

The study of natural plant compounds for biological and pharmacological purposes has revealed a vast resource of compounds and their metabolites. The effect of these natural plant compounds and their metabolites on biofilms of beneficial bacteria, including the Bacilli subgroup, and on pathogenic bacteria, including the genus of Pseudomonas, remains unknown.

The use of B. subtilis as beneficial bio-control agent may answer an immediate ecological need: the environmental problems caused by the overuse of pesticides. Traditional solutions for fungal and bacterial infections have two cardinal problems: (1) the high toxicity and non-biodegradable properties of pesticides and (2) the residues in soil, water resources and crops that affect public health. The use of beneficial bacteria such as B. subtilis as a ‘protective armor’ may be a cutting edge solution to the pesticides problem. Inclusion of pathogenic bacteria within a study may provide answers to both the positive and negative effects a plant compound may have on biofilm formation and induction, enabling selectivity in use.

However, there remains a need to induce or enhance biofilm formation in beneficial bacterial while preserving the bacterial biological activity. Alternatively, there remains a need to inhibit induction or enhancement of biofilm formation in pathogenic bacteria. The present disclosure addresses these needs by providing a screen of natural plant compounds and metabolites thereof, in order to identify and provide methods of use of natural plant compounds for inducing and enhancing biofilms produced by beneficial communities, as well as identifying and providing methods of use of natural plant compounds for inhibition of biofilm and pellicle production by pathogenic bacteria, and inhibition of adhesion of pathogenic bacteria to a biofilm. In addition, described herein are natural plant compounds or metabolites thereof, and methods of use thereof for stimulating matrix production by the beneficial bacteria.

### SUMMARY OF THE DISCLOSURE

In one aspect, described herein is a method for inducing biofilm formation by a beneficial rhizobacteria, said method comprising the step of applying an effective amount of a composition comprising a natural plant compound or a metabolite thereof to the beneficial rhizobacteria, wherein said natural plant compound or a metabolite thereof is selected from the group comprising cornuside, 2-(3,4-dihydroxyphenyl)-5-hydroxy-3,6,7-trimethoxy-4H-chromen-4-one, isothymonin, and 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one.

In another aspect, described herein is a method for enhancing biofilm formation by a beneficial rhizobacteria, said method comprising the step of applying an effective amount of a composition comprising a natural plant compound or a metabolite thereof to the beneficial rhizobacteria, wherein said natural plant compound or a metabolite thereof is selected from the group comprising cornuside, 2-(3,4-dihydroxyphenyl)-5-hydroxy-3,6,7-trimethoxy-4H-chromen-4-one, isothymonin, and a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one.

In yet another aspect, described herein is a method for enhancing transcription of matrix genes in a beneficial rhizobacteria, said method comprising the step of applying an effective amount of a composition comprising a natural plant compound or a metabolite thereof to the beneficial rhizobacteria, wherein said natural plant compound or a metabolite thereof is selected from the group comprising cornuside, 2-(3,4-dihydroxyphenyl)-5-hydroxy-3,6,7-trimethoxy-4H-chromen-4-one, isothymonin, and 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one. In a related aspect, matrix genes comprise sinI or tapA, or a combination thereof.

In still another aspect, described herein is method stimulating matrix production by a beneficial rhizobacteria, said method comprising the step of applying an effective amount of a composition comprising a natural plant compound or a metabolite thereof to the beneficial rhizobacteria, wherein said natural plant compound or a metabolite thereof is selected from the group comprising cornuside, 2-(3,4-dihydroxyphenyl)-5-hydroxy-3,6,7-trimethoxy-4H-chromen-4-one, isothymonin, and 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one.

In a related aspect, the natural plant compound is its derivative, isomer, tautomer, hydrate, salt, or a combination thereof. In another related aspect, biofilm formation is on a plant or a plant part. In another related aspect, plant or plant part comprises a plant root or part thereof.

In a related aspect, the method increases pathogen resistance in a plant or a part thereof. In another related aspect, the pathogen comprises a fungus or a bacterium. In another related aspect, the beneficial rhizobacteria comprises a Bacillus subtilis (B. subtilis) species. In another related aspect, the B. subtilis is selected from the group comprising B. subtilis NCBI 3610, B. subtilis FB17, B. subtilis NATTO, B. subtilis CPA-8, B. subtilis RO-FF-1, B. subtilis JH642, B. subtilis GB03, B. Subtilis E1R-J, and B. subtilis FZB37.

In a related aspect, the composition comprises a plant extract. In a related aspect, the composition comprises a combination of said natural plant compound or metabolite thereof, and any other active compound from the same plant source as the natural plant compound. In another related aspect, the natural compound is purified from a plant. In another related aspect, any other active compound from the same plant may be purified from said plant. In another related aspect, the natural compound comprises a semi-synthetic or a synthetic variant.

In a related aspect, said composition is applied directly to the beneficial rhizobacteria spores. In another related aspect, the composition is applied to a biofilm formed by a beneficial rhizobacteria. In another related aspect, the applying further comprises applying said composition to spores of said rhizobacteria prior to, concurrent with, or following application of said natural compound to the biofilm formed by said beneficial rhizobacteria. In another related aspect, the application comprises applying said natural compound or a metabolite thereof at a dose of about 1 μM.

In a related aspect, the natural compound at a concentration of about 1 μM. In another related aspect, the composition comprises a solution, a powder, a spray, drops, a tablet, or a paste. In a further related aspect, solution or said spray comprises an aqueous solution or an aqueous spray.

In another aspect, disclosed herein is a method for inhibiting biofilm formation by a plant pathogen, said method comprising the step of applying an effective amount of a composition comprising a natural plant compound or a metabolite thereof to the plant pathogen, wherein said natural plant compound or a metabolite thereof is selected from the group comprising a (E)-2-(3,7-dimethylocta-2,6-dien-1-yl)-5-pentylbenzene-1,3-diol and a eupahakonenin B compound.

In another aspect, disclosed herein is a method for inhibiting pellicle formation by a plant pathogen, said method comprising the step of applying an effective amount of a composition comprising a natural plant compound or a metabolite thereof to the plant pathogen, wherein said natural plant compound or a metabolite thereof is selected from the group comprising a (E)-2-(3,7-dimethylocta-2,6-dien-1-yl)-5-pentylbenzene-1,3-diol and a eupahakonenin B compound.

In another aspect, disclosed herein is a method for inhibiting attachment of a plant pathogen to a biofilm, said method comprising the step of applying an effective amount of a composition comprising a natural plant compound or a metabolite thereof to said plant pathogen, wherein said natural plant compound or a metabolite thereof is selected from the group comprising a (E)-2-(3,7-dimethylocta-2,6-dien-1-yl)-5-pentylbenzene-1,3-diol and a eupahakonenin B compound.

In a related aspect, disclosed herein is a (E)-2-(3,7-dimethylocta-2,6-dien-1-yl)-5-pentylbenzene-1,3-diol. In another related aspect, the (E)-2-(3,7-dimethylocta-2,6-dien-1-yl)-5-pentylbenzene-1,3-diolis its derivative, isomer, tautomer, hydrate, salt, or a combination thereof.

In a related aspect, the biofilm formation and/or the pellicle formation is on a plant or a plant part, and said attachment is to a biofilm associated with a plant or a plant part. In another related aspect, the plant or plant part comprises a root or a part thereof. In another related aspect, the pathogen comprises a fungus or a bacterium. In another related aspect, the plant pathogen comprises a pseudomonas species. In another related aspect, the pseudomonas species is selected from the group comprising P. sytingae pv tomato.

In a related aspect, the composition comprises a plant extract. In another related aspect, the composition comprises a combination of said natural plant compound or metabolite thereof, and any other active compound from the same plant source as the natural plant compound.

In another related aspect, the natural compound is purified from a plant. In another related aspect, any other active compound from the same plant may be purified from said plant. In another related aspect, the natural compound comprises a semi-synthetic or a synthetic variant.

In a related aspect, the composition is applied to a biofilm. In another related aspect, the composition is applied to a plant surface or a portion thereof. In another aspect, the application comprises applying said natural compound or a metabolite thereof at a dose of about 1-2 μM. In another related aspect, the composition comprises said natural compound or a metabolite thereof at a concentration of about 1-2 μM. In another related aspect, the composition comprises a solution, a powder, a spray, drops, a tablet, or a paste. In another related aspect, said solution or said spray comprising an aqueous solution or an aqueous spray.

In a related aspect, the natural compound inhibits formation of a beneficial rhizobacteria biofilm to a lesser extent than the inhibition of said plant pathogen biofilm. In another related aspect, the beneficial rhizobacteria comprises a Bacillus subtilis (B. subtilis) species. In another related aspect, the B. subtilis is selected from the group comprising B. subtilis NCBI 3610, B. subtilis FB17, B. subtilis NATTO, B. subtilis CPA-8, B. subtilis RO-FF-1, B. subtilis JH642, B. subtilis GB03, B. Subtilis E1R-J, and B. subtilis FZB37.

Other features and advantages will become apparent from the following detailed description, examples and figures. It should be understood, however, that the detailed description and the specific examples while indicating embodiments of the disclosure are given by way of illustration only, since various changes and modification within the spirit and scope of the disclosure will become apparent to those skilled in the art from this detailed description.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 presents the biofilm formation screening layout.

FIGS. 2A and 2B present natural compounds that promote biofilm formation in the biocontrol agent B. subtilis 3610. FIG. 2A shows the level of induction of biofilm formation in percent (%). One mg (1 mg) of each natural product was used in the screen. Novelty refers to biofilm promoting activity. Natural plant products were ordered from AnalytiCon Discovery GmbH, Germany (http://www.ac-discovery.com/). Percent induction was compared with biofilm formation in the absence of any added plant product. FIG. 2B presents the chemical structure of the natural products.

FIGS. 3A, 3B, and 3C show that natural compounds identified in FIG. 2, specifically enhance biofilm formation and transcription of matrix genes in the beneficial bacterium B. subtilis. FIG. 3A shows top-down images of floating biofilms grown under static conditions in liquid MSgg medium for 1 day at 30° C. with or without (not treated—NT) 1 μM of the natural compound. NT refers to not treated. FIG. 3B presents data showing the transcription level of sinI using luciferase as a reporter gene, as measured over time, wherein normalized units of luminescence (luminescence divided by OD₆₀₀) are used. FIG. 3C presents data showing the transcription of tapA (Matrix promoter) using green fluorescent protein as reporter and the measured time course of normalized units of fluorescence (fluorescence divided by OD₆₀₀).

FIGS. 4A and 4B presents natural compounds that inhibit biofilm formation in the biocontrol agent B. subtilis 3610. FIG. 4A shows growth of biofilms were inhibited by the compounds presented. The 1 mg of each natural product was used in the screen. Novelty refers to biofilm promoting activity. Natural plant products were ordered from AnalytiCon Discovery GmbH, Germany (http://www.ac-discovery.com/). FIG. 4B presents the chemical structure of the natural products.

FIG. 5 shows Pellicle formation in the presence and absence of natural compounds that inhibit biofilm formation.

FIG. 6 shows the results of quantification of submerged biofilm formation by P. sytingae pv tomato in standardized media (TSB) following 24 hours of incubation with the natural compounds in a 96 well plate.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

Biofilms

Bacteria are able to grow adhered to almost every surface, forming architecturally complex communities called biofilms. Biofilms are communities of cells that settle and proliferate on surfaces and are covered by an exopolymer matrix. The bacteria within a biofilm are slow-growing and many are in the stationary phase of growth. In one embodiment, as used herein the term “biofilm” refers to a multicellular community or communities held together by a self-produced extracellular matrix that may comprise exopolysaccharides (EPSs), proteins, and sometimes DNA. In another embodiment, a biofilm comprises an extracellular matrix comprising exopolysaccharides. In another embodiment, a biofilm comprises an extracellular matrix comprising exopolysaccharides expressed and secreted by the bacteria.

Biofilm development occurs by a series of programmed steps, which include initial attachment to a surface, formation of three-dimensional micro-colonies, and the subsequent development of a mature biofilm. The more deeply a cell is located within a biofilm (such as, the closer the cell is to the solid surface to which the biofilm is attached to, thus being more shielded and protected by the bulk of the biofilm matrix), the more metabolically inactive the cells are. The consequences of this physiologic variation and gradient create a collection of bacterial communities where there is an efficient system established whereby microorganisms have diverse functional traits. A biofilm may be made up of various and diverse non-cellular components and may include, but is not limited to carbohydrates (simple and complex), lipids, proteins (including polypeptides), and lipid complexes of sugars and proteins (lipopolysaccharides and lipoproteins). A biofilm may include an integrated community of two or more bacteria species (polymicrobic biofilms) or predominantly one specific bacterium.

However, it will be understood by those skilled in the art that as biofilms age, nutrients become limiting, waste compounds accumulate, and it is advantageous for the biofilm-associated bacteria to return to a planktonic existence. Thus, biofilms have a finite lifetime, characterized by eventual disassembly. In certain embodiments, the lifetime of a biofilm is a season. In other embodiments, the lifetime of a biofilm is less than a season, while in an alternated embodiment, the lifetime of a biofilm is more than a season.

Three major types of biofilms can occur in the soil: bacterial, fungal, and fungal-bacterial biofilms Both bacterial and fungal biofilms are formed on abiotic surfaces, while fungi act as the biotic surface in formation of fungal-bacterial biofilms. The majority of plant-associated bacteria found on roots and in soil are forming biofilms Therefore, use of beneficial bacterial strains for forming biofilms could be a strategy to protect plants from pathogens.

In one embodiment, biofilms form and adhere to a plant or parts thereof. Biofilms may be found on the aerial surfaces of plants as well as on the vasculature, roots, and root hair surfaces. In another embodiment, a biofilm is formed by a beneficial rhizobacteria, for example a Bacillus subtilis (B. subtilis) bacteria. In another embodiment, a biofilm is formed by a pathogenic bacteria, for example a Pseudomonas. In another embodiment, a biofilm formed on a plant or a plant surface by an associated beneficial bacteria may confer benefits to the plant. In another embodiment, a biofilm as described herein adheres to a plant root surface. In another embodiment, a biofilm as described herein adheres to a plant root hair surface. In another embodiment, a biofilm as described herein adheres to a plant root and plant root hair surfaces. It will be understood by those skilled in the art that the term “root” may in certain embodiments, include root hairs. In another embodiment, a biofilm as described herein adheres to a surface of a plant or part thereof, increasing pathogen resistance in the plant or part thereof.

Biofilm structure varies with conditions; indeed, different forms of biofilms, such as plaques, slimes, pellicles, and colonies, have been observed under different environmental conditions. In one embodiment, strains of rhizobacteria, for example, Bacillus subtilis, produce a floating biofilm called a pellicle with a distinct macroscopic architecture. In another embodiment, strains of pathogenic bacteria, for example, Pseudomonas, produce a floating biofilm called a pellicle with a distinct macroscopic architecture. Pellicle formation begins with the formation of cell chains, which is followed by clustering and degradation of cell chains. In one embodiment, a biofilm described herein comprises a biofilm floating at the airliquid interface (a pellicle).

In one embodiment, described herein are methods for inducing or enhancing or maintaining biofilm formation by a beneficial rhizobacteria, the method comprising the step of applying a composition comprising an effective amount of a natural plant compound or a metabolite thereof to the beneficial rhizobacteria, thereby inducing, enhancing, or maintaining said biofilm formation. In one embodiment, described herein are methods for inducing, enhancing or maintaining biofilm formation by a beneficial rhizobacteria, the method comprising the step of applying a composition comprising an effective amount of a natural plant compound or a metabolite thereof, wherein said natural plant compound or metabolite thereof is selected from the group comprising a cornuside ((2S,3R,4S)-methyl 2-((3,4,5-trihydroxy-6-(hydroxymethyl)tetrahydro-2H-pyran-2-yl)oxy)-4-(2-((3,4,5-trihydroxybenzoyl)oxy)ethyl)-3-vinyl-3,4-dihydro-2H-pyran-5-carboxylate), a 2-(3,4-dihydroxyphenyl)-5-hydroxy-3,6,7-trimethoxy-4H-chromen-4-one, an isothymonin (5,8-dihydroxy-2-(4-hydroxy-3-methoxyphenyl)-6,7-dimethoxy-4H-chromen-4-one), and a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, to the beneficial rhizobacteria, thereby inducing, enhancing, or maintaining said biofilm formation. In another embodiment, said biofilm formation is on a plant or a part thereof.

In one embodiment, described herein are methods for stimulating production of a biofilm matrix by a beneficial rhizobacteria, the method comprising the step of applying a composition comprising an effective amount of a natural plant compound or a metabolite thereof to the beneficial rhizobacteria, thereby stimulating production of said biofilm matrix. In one embodiment, described herein are methods for stimulating production of a biofilm matrix by a beneficial rhizobacteria, the method comprising the step of applying a composition comprising an effective amount of a natural plant compound or a metabolite thereof, wherein said natural plant compound or metabolite thereof is selected from the group comprising a cornuside, a 2-(3,4-dihydroxyphenyl)-5-hydroxy-3,6,7-trimethoxy-4H-chromen-4-one, an isothymonin, and a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, to the beneficial rhizobacteria, thereby stimulating production of said biofilm matrix. In another embodiment, said biofilm is on a plant or a part thereof.

In one embodiment, described herein are methods for enhancing transcription of matrix genes in a beneficial rhizobacteria, the method comprising the step of applying a composition comprising an effective amount of a natural plant compound or a metabolite thereof to the beneficial rhizobacteria, thereby stimulating production of said biofilm matrix. In one embodiment, described herein are methods for enhancing transcription of matrix genes in a beneficial rhizobacteria, the method comprising the step of applying a composition comprising an effective amount of a natural plant compound or a metabolite thereof, wherein said natural plant compound or metabolite thereof is selected from the group comprising a cornuside, a 2-(3,4-dihydroxyphenyl)-5-hydroxy-3,6,7-trimethoxy-4H-chromen-4-one, an isothymonin, and a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, to the beneficial rhizobacteria, thereby stimulating production of said biofilm matrix. In another embodiment, said biofilm is on a plant or a part thereof.

In one embodiment, described herein are methods for inhibiting biofilm formation by a plant pathogen, the method comprising the step of applying a composition comprising an effective amount of a natural plant compound or a metabolite thereof to the plant pathogen or biofilm thereof, thereby inhibiting said biofilm formation. In one embodiment, described herein are methods for inhibiting biofilm formation by a plant pathogen, the method comprising the step of applying a composition comprising an effective amount of a natural plant compound or a metabolite thereof, wherein said natural plant compound or metabolite thereof is selected from the group comprising a (E)-2-(3,7-dimethylocta-2,6-dien-1-yl)-5-pentylbenzene-1,3-diol and a eupahakonenin B, to the plant pathogen or biofilm thereof, thereby inhibiting said biofilm formation. In another embodiment, said biofilm formation is on a plant or a part thereof.

In one embodiment, described herein are methods for inhibiting pellicle formation by a plant pathogen, the methods comprising the step of applying a composition comprising an effective amount of a natural plant compound or a metabolite thereof to the plant pathogen or biofilm thereof, thereby inhibiting said pellicle formation. In one embodiment, described herein are methods for inhibiting pellicle formation by a plant pathogen, the method comprising the step of applying a composition comprising an effective amount of a natural plant compound or a metabolite thereof, wherein said natural plant compound or metabolite thereof is selected from the group comprising a (E)-2-(3,7-dimethylocta-2,6-dien-1-yl)-5-pentylbenzene-1,3-diol and a eupahakonenin B, to the plant pathogen or biofilm thereof, thereby inhibiting said pellicle formation. In another embodiment, said biofilm formation is on a plant or a part thereof.

In one embodiment, described herein are methods for inhibiting attachment of a plant pathogen to a biofilm, the method comprising the step of applying a composition comprising an effective amount of a natural plant compound or a metabolite thereof to the plant pathogen or biofilm thereof, thereby inhibiting said of a plant pathogen to a biofilm. In one embodiment, described herein are methods for inhibiting of a plant pathogen to a biofilm, the method comprising the step of applying a composition comprising an effective amount of a natural plant compound or a metabolite thereof, wherein said natural plant compound or metabolite thereof is selected from the group comprising a (E)-2-(3,7-dimethylocta-2,6-dien-1-yl)-5-pentylbenzene-1,3-diol and a eupahakonenin B, to the plant pathogen or biofilm thereof, thereby inhibiting said of a plant pathogen to said biofilm. In another embodiment, said attachment is to a biofilm attached to plant or a part thereof.

Biofilm-Forming Bacteria

Biofilm-forming bacteria may provide a beneficial service to the surface or item to which they are adhered. For example, formation, enhancement or maintenance, or any combination thereof, of a biofilm on a plant surface or part thereof by biofilm-forming bacteria may provide a resistance to plant pathogens that could otherwise harm or kill the plant. Biofilm-forming bacteria are thus termed “beneficial bacteria”. Beneficial bacteria include, but are not limited to, rhizobacteria. Rhizobacteria are root-colonizing bacteria that form symbiotic relationships with many plants. Beneficial rhizobacteria may also be known as plant growth-promoting bacteria or plant growth promoting rhizobacteria (PGPR). The term “beneficial rhizobacteria”, may be used interchangeably with the terms “plant growth-promoting bacteria”, “plant growth promoting rhizobacteria”, “PGPR”, and “rhizobacteria”, having all the same meanings and qualities. In some embodiments, the term “beneficial rhizobacteria” refers to spores of beneficial rhizobacteria.

In one embodiment, a beneficial rhizobacteria used in methods described herein comprises a Bacillus subtilis (B. subtilis) species. In another embodiment, a beneficial rhizobacteria is a root colonizing bacteria. In another embodiment, the Bacillus subtilis species is selected from the group comprising B. subtilis FB17, B. subtilis NCIB3610, B. subtilis NATTO, Bacillus subtilis CPA-8, B. subtilis RO-FF-1, B. subtilis JH642, B. subtilis GB03, Bacillus subtilis Strain E1R-J. Bacillus amyloliquefaciens FZB24, FZB42, FZB45 and Bacillus subtilis FZB37.

B. subtilis, for example, forms architecturally complex communities on semi-solid surfaces and thick pellicles at the air/liquid interface of standing cultures B. subtilis biofilms consist of long chains of cells held together by an extracellular matrix consisting of an exopolysaccharide and amyloid fibers composed of the protein TasA The exopolysaccharide is produced by enzymes encoded by the epsA-O operon (“eps operon”) and the TasA protein is encoded by the promoter-distal gene of the yqxM-sipW-tasA operon (“yqxM operon”). In another embodiment, a beneficial rhizobacteria comprises a sinI matrix regulator gene pathway. In another embodiment, the Bacillus subtilis species comprises a sinI matrix regulator gene pathway

In one embodiment, a beneficial rhizobacteria, for example a B. subtilis used in the methods described herein, comprises rhizobacteria spores, for example B. subtilis spores.

In an alternative embodiment, a biofilm may be formed by pathogenic bacteria, for example pseudomonas. Biofilm formation by pathogenic bacteria on plants may be associated with pathogenic responses of the plant. Biofilm development may also contribute to the virulence of phytopathogenic bacteria through various mechanisms, including blockage of xylem vessels, increased resistance to plant antimicrobial compounds, and/or enhanced colonization of specific habitats.

In one embodiment, a plant pathogen comprises a pseudomonas species. In another embodiment, a pseudomonas species is selected from the group comprising P. sytingae pv tomato and P. fluroescens PFZ-79.

Natural Plant Compounds and Metabolites Thereof

A skilled artisan would appreciate that the term “biocontrol enhancer” may encompass compounds and methods of use thereof to control plant pathogen development. In one embodiment, a biocontrol enhancer enhances the effectiveness of a beneficial rhizobacteria. In another embodiment, a biocontrol enhancer inhibits the effectives of a plant pathogen.

A skilled artisan would appreciate that the term “Natural Plant compound” encompasses products made from a plant, wherein it may also be termed a “Natural Plant product” having all the same qualities and meanings. As well the skilled artisan would appreciate that a natural plant product may be able to be synthetically produced.

In one embodiment, disclosed herein are methods comprising applying a composition comprising an effective amount of a composition comprising a natural plant compound or a metabolite thereof or its derivative, isomer, tautomer, hydrate, salt or combination thereof, to a beneficial rhizobacterium, wherein said natural plant compound or metabolite thereof is selected from the group comprising a cornuside, a 2-(3,4-dihydroxyphenyl)-5-hydroxy-3,6,7-trimethoxy-4H-chromen-4-one, an isothymonin, and a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one.

In another embodiment, said natural plant compound or the metabolite thereof is a cornuside. In another embodiment, the cornuside has the formula of C₂₄H₃₀O₁₄. Cornuside is an iridoid, which may be isolated from plants of the genus cornus. Cornus is a genus of about 30-60 species of woody plants in the family Cornaceae, commonly known as dogwoods. In another embodiment, additional compounds having beneficial properties may be extracted from plants of the genus Cornus. In another embodiment, additional compounds having beneficial properties may be isolated from plants of the genus Cornus.

In another embodiment, said natural plant compound or the metabolite thereof is a 2-(3,4-dihydroxyphenyl)-5-hydroxy-3,6,7-trimethoxy-4H-chromen-4-one. In another embodiment, the 2-(3,4-dihydroxyphenyl)-5-hydroxy-3,6,7-trimethoxy-4H-chromen-4-one has the formula C₁₈H₁₆O₈. In another embodiment, 2-(3,4-dihydroxyphenyl)-5-hydroxy-3,6,7-trimethoxy-4H-chromen-4-one may be isolated from plants from the genus Teucrium. Teucrium is a genus of perennial plants in the family Lamiaceae. In another embodiment, additional compounds having beneficial properties may be extracted from plants of the genus Teucrium. In another embodiment, additional compounds having beneficial properties may be isolated from plants of the genus Teucrium.

In another embodiment, said natural plant compound or the metabolite thereof is an isothymonin. In another embodiment, the isothymonin has the formula C₁₈H₁₆O₈. In another embodiment, isothymonin may be isolated from plants from of the genus Salvia. Salvia is the largest genus of plants in the mint family, Lamiaceae, with nearly 1000 species of shrubs, herbaceous perennials, and annuals. In another embodiment, additional compounds having beneficial properties may be extracted from plants of the genus Salvia. In another embodiment, additional compounds having beneficial properties may be isolated from plants of the genus Salvia

In another embodiment, said natural plant compound or the metabolite thereof is a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one has the formula C₂₈H₃₂O₁₇. In another embodiment, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one may be isolated from plants from the genus Spondias. Spondias is a genus of flowering plants in the cashew family, Anacardiaceae. In another embodiment, additional compounds having beneficial properties may be extracted from plants of the genus Spondias. In another embodiment, additional compounds having beneficial properties may be isolated from plants of the genus Spondias.

In one embodiment, disclosed herein are methods comprising applying a composition comprising an effective amount of a composition comprising a natural plant compound or a metabolite thereof or its derivative, isomer, tautomer, hydrate, salt or combination thereof, to a pathogenic bacteria or biofilin thereof, wherein said natural plant compound or metabolite thereof is selected from the group comprising an eupahakonenin B and a (E)-2-(3,7-dimethylocta-2,6-dien-1-yl)-5-pentylbenzene-1,3-diol.

In another embodiment, said natural plant compound or the metabolite thereof is an eupahakonenim B. In another embodiment, the eupahakonenim B has the formula C₂₆H₄₂O₆. In another embodiment, the eupahakonenim B may be isolated from plants from the genus Stevia. Stevia is a genus comprising species of herbs and shrubs in the sunflower family Asteraceae. In another embodiment, additional compounds having inhibitory properties may be extracted from plants of the genus Stevia. In another embodiment, additional compounds having inhibitory properties may be isolated from plants of the genus Stevia.

In another embodiment, said natural plant compound or the metabolite thereof is from the Cannabis genus and is a (E)-2-(3,7-dimethylocta-2,6-dien-1-yl)-5-pentylbenzene-1,3-diol. In another embodiment, a (E)-2-(3,7-dimethylocta-2,6-dien-1-yl)-5-pentylbenzene-1,3-diol has the formula C₂₁H₃₂O₂ Cannabis is a genus of flowering plant that includes three species or subspecies, sativa, indica, and ruderalis. In another embodiment, additional compounds having inhibitory properties may be extracted from plants of the genus Cannabis. In another embodiment, additional compounds having inhibitory properties may be isolated from plants of the genus Cannabis.

In one embodiment, provided herein is a natural plant compound or a metabolite thereof as disclosed herein, or its derivative, tautomer, hydrate, isomer, salt thereof or combinations thereof. In another embodiment, provided herein is a cornuside, or its derivative, tautomer, hydrate, isomer, salt thereof or combinations thereof. In another embodiment, provided herein is a 2-(3,4-dihydroxyphenyl)-5-hydroxy-3,6,7-trimethoxy-4H-chromen-4-one, or its derivative, tautomer, hydrate, isomer, salt thereof or combinations thereof. In another embodiment, provided herein is a isothymonin, or its derivative, tautomer, hydrate, isomer, salt thereof or combinations thereof. In another embodiment, provided herein is a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, or its derivative, tautomer, hydrate, isomer, salt thereof or combinations thereof. In another embodiment, provided herein is a eupahakonenin B, or its derivative, tautomer, hydrate, isomer, salt thereof or combinations thereof. In another embodiment, provided herein is a (E)-2-(3,7-dimethylocta-2,6-dien-1-yl)-5-pentylbenzene-1,3-diol, or its derivative, tautomer, hydrate, isomer, salt thereof or combinations thereof. In another embodiment, provided herein is a cornuside, or its derivative, tautomer, hydrate, isomer, salt thereof or combinations thereof.

In another embodiment, provided herein is an isomer of cornuside. In another embodiment, provided herein is an isomer of 2-(3,4-dihydroxyphenyl)-5-hydroxy-3,6,7-trimethoxy-4H-chromen-4-one. In another embodiment, provided herein is an isomer of isothymonin. In another embodiment, provided herein is an isomer of a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one. In another embodiment, provided herein is an isomer of eupahakonenin B. In another embodiment, provided herein is an isomer of a (E)-2-(3,7-dimethylocta-2,6-dien-1-yl)-5-pentylbenzene-1,3-diol.

In another embodiment, provided herein is a salt of cornuside. In another embodiment, provided herein is a salt of 2-(3,4-dihydroxyphenyl)-5-hydroxy-3,6,7-trimethoxy-4H-chromen-4-one. In another embodiment, provided herein is a salt of isothymonin. In another embodiment, provided herein is a salt of a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one. In another embodiment, provided herein is a salt of eupahakonenin B. In another embodiment, provided herein is a salt of a (E)-2-(3,7-dimethylocta-2,6-dien-1-yl)-5-pentylbenzene-1,3-diol.

In another embodiment, provided herein is a derivative of cornuside. In another embodiment, provided herein is a derivative of 2-(3,4-dihydroxyphenyl)-5-hydroxy-3,6,7-trimethoxy-4H-chromen-4-one. In another embodiment, provided herein is a derivative of isothymonin. In another embodiment, provided herein is a derivative of a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one. In another embodiment, provided herein is a derivative of eupahakonenin B. In another embodiment, provided herein is a derivative of a (E)-2-(3,7-dimethylocta-2,6-dien-1-yl)-5-pentylbenzene-1,3-diol.

In another embodiment, provided herein is a tautomer of cornuside. In another embodiment, provided herein is a tautomer of 2-(3,4-dihydroxyphenyl)-5-hydroxy-3,6,7-trimethoxy-4H-chromen-4-one. In another embodiment, provided herein is a tautomer of isothymonin. In another embodiment, provided herein is a tautomer of a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one. In another embodiment, provided herein is a tautomer of eupahakonenin B. In another embodiment, provided herein is a tautomer of a (E)-2-(3,7-dimethylocta-2,6-dien-1-yl)-5-pentylbenzene-1,3-diol.

In another embodiment, provided herein is a hydrate of cornuside. In another embodiment, provided herein is a hydrate of 2-(3,4-dihydroxyphenyl)-5-hydroxy-3,6,7-trimethoxy-4H-chromen-4-one. In another embodiment, provided herein is a hydrate of isothymonin. In another embodiment, provided herein is a hydrate of a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one. In another embodiment, provided herein is a hydrate of eupahakonenin B. In another embodiment, provided herein is a hydrate of a (E)-2-(3,7-dimethylocta-2,6-dien-1-yl)-5-pentylbenzene-1,3-diol.

In another embodiment, provided herein is a composition comprising a cornuside, as described herein, or, in another embodiment, a combination of the derivative, isomer, salt, tautomer, hydrate, of the cornuside. In another embodiment, compositions comprising cornuside further comprise any other active compound extracted from plants of the genus Cornus. In another embodiment, compositions comprising cornuside further comprise any other active compound isolated from plants of the genus Cornus.

In another embodiment, provided herein is a composition comprising a 2-(3,4-dihydroxyphenyl)-5-hydroxy-3,6,7-trimethoxy-4H-chromen-4-one, as described herein, or, in another embodiment, a combination of the derivative, isomer, salt, tautomer, hydrate, of the 2-(3,4-dihydroxyphenyl)-5-hydroxy-3,6,7-trimethoxy-4H-chromen-4-one. In another embodiment, compositions comprising 2-(3,4-dihydroxyphenyl)-5-hydroxy-3,6,7-trimethoxy-4H-chromen-4-one, as described herein, or, in another embodiment, a combination of the derivative, isomer, salt, tautomer, hydrate, of the 2-(3,4-dihydroxyphenyl)-5-hydroxy-3,6,7-trimethoxy-4H-chromen-4-one further comprise any other active compound extracted from plants of the genus Teucrium. In another embodiment, compositions comprising 2-(3,4-dihydroxyphenyl)-5-hydroxy-3,6,7-trimethoxy-4H-chromen-4-one, as described herein, or, in another embodiment, a combination of the derivative, isomer, salt, tautomer, hydrate, of the 2-(3,4-dihydroxyphenyl)-5-hydroxy-3,6,7-trimethoxy-4H-chromen-4-one further comprise any other active compound isolated from plants of the genus Teucrium.

In another embodiment, provided herein is a composition comprising a isothymonin, as described herein, or, in another embodiment, a combination of the derivative, isomer, salt, tautomer, hydrate, of the isothymonin. In another embodiment, compositions comprising isothymonin further comprise any other active compound extracted from plants of the genus Salvia. In another embodiment, compositions comprising isothymonin further comprise any other active compound isolated from plants of the genus Salvia.

In another embodiment, provided herein is a composition comprising a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, as described herein, or, in another embodiment, a combination of the derivative, isomer, salt, tautomer, hydrate, of the 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one. In another embodiment, compositions comprising 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one further comprise any other active compound extracted from plants of the genus Spondias. In another embodiment, compositions comprising 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one further comprise any other active compound isolated from plants of the genus Spondias.

In another embodiment, provided herein is a composition comprising a eupahakonenin B, as described herein, or, in another embodiment, a combination of the derivative, isomer, salt, tautomer, hydrate, of the eupahakonenin B. In another embodiment, compositions comprising eupahakonenin B further comprise any other active compound extracted from plants of the genus Stevia. In another embodiment, compositions comprising eupahakonenin B further comprise any other active compound isolated from plants of the genus Stevia.

In another embodiment, provided herein is a composition comprising a (E)-2-(3,7-dimethylocta-2,6-dien-1-yl)-5-pentylbenzene-1,3-diol, as described herein, or, in another embodiment, a combination of the derivative, isomer, salt, tautomer, hydrate, of the (E)-2-(3,7-dimethylocta-2,6-dien-1-yl)-5-pentylbenzene-1,3-diol. In another embodiment, compositions comprising (E)-2-(3,7-dimethylocta-2,6-dien-1-yl)-5-pentylbenzene-1,3-diol further comprise any other active compound extracted from plants of the genus Cannabis. In another embodiment, compositions comprising (E)-2-(3,7-dimethylocta-2,6-dien-1-yl)-5-pentylbenzene-1,3-diol further comprise any other active compound isolated from plants of the genus Cannabis.

In one embodiment, the term “isomer” includes, but is not limited to, optical isomers and analogs, structural isomers and analogs, conformational isomers and analogs, and the like.

Natural compounds or metabolites thereof of the present invention can also be in the form of a hydrate, which means that the compound further includes a stoichiometric or non-stoichiometric amount of water bound by non-covalent intermolecular forces.

Natural compounds or metabolites thereof of the present invention may exist in the form of one or more of the possible tautomers and depending on the particular conditions it may be possible to separate some or all of the tautomers into individual and distinct entities. It is to be understood that all of the possible tautomers, including all additional enol and keto tautomers and/or isomers are hereby covered.

In one embodiment, “salts” of the natural compounds or metabolites thereof described herein, may be produced, by reaction of a natural compound described herein with an acid or base. Certain natural compounds, particularly those possessing acid or basic groups, can also be in the form of a salt, The salts are formed with inorganic acids such as hydrochloric acid, hydrobromic acid, sulfuric acid, nitric acid, phosphoric acid and the like, and organic acids such as acetic acid, propionic acid, glycolic acid, pyruvic acid, oxylic acid, maleic acid, malonic acid, succinic acid, fumaric acid, tartaric acid, citric acid, benzoic acid, cinnamic acid, mandelic acid, methanesulfonic acid, ethanesulfonic acid, p-toluenesulfonic acid, salicylic acid, N-acetylcysteine and the like. Other salts are known to those of skill in the art and can readily be adapted for use in accordance with the description herein.

Suitable salts of amines may be prepared from an inorganic acid or from an organic acid. In one embodiment, examples of inorganic salts of amines are bisulfates, borates, bromides, chlorides, hemisulfates, hydrobromates, hydrochlorates, 2-hydroxyethylsulfonates (hydroxyethanesulfonates), iodates, iodides, isothionates, nitrates, persulfates, phosphate, sulfates, sulfamates, sulfanilates, sulfonic acids (alkylsulfonates, arylsulfonates, halogen substituted alkylsulfonates, halogen substituted arylsulfonates), sulfonates and thiocyanates.

In one embodiment, examples of organic salts of amines may be selected from aliphatic, cycloaliphatic, aromatic, araliphatic, heterocyclic, carboxylic and sulfonic classes of organic acids, examples of which are acetates, arginines, aspartates, ascorbates, adipates, anthranilates, algenates, alkane carboxylates, substituted alkane carboxylates, alginates, benzenesulfonates, benzoates, bisulfates, butyrates, bicarbonates, bitartrates, citrates, camphorates, camphorsulfonates, cyclohexylsulfamates, cyclopentanepropionates, calcium edetates, camsylates, carbonates, clavulanates, cinnamates, dicarboxylates, digluconates, dodecylsulfonates, dihydrochlorides, decanoates, enanthuates, ethanesulfonates, edetates, edisylates, estolates, esylates, fumarates, formates, fluorides, galacturonates gluconates, glutamates, glycolates, glucorate, glucoheptanoates, glycerophosphates, gluceptates, glycollylarsanilates, glutarates, glutamate, heptanoates, hexanoates, hydroxymaleates, hydroxycarboxlic acids, hexylresorcinates, hydroxybenzoates, hydroxynaphthoates, hydrofluorates, lactates, lactobionates, laurates, malates, maleates, methylenebis(beta-oxynaphthoate), malonates, mandelates, mesylates, methane sulfonates, methylbromides, methylnitrates, methylsulfonates, monopotassium maleates, mucates, monocarboxylates, naphthalenesulfonates, 2-naphthalenesulfonates, nicotinates, nitrates, napsylates, N-methylglucamines, oxalates, octanoates, oleates, pamoates, phenylacetates, picrates, phenylbenzoates, pivalates, propionates, phthalates, phenylacetate, pectinates, phenylpropionates, palmitates, pantothenates, polygalacturates, pyruvates, quinates, salicylates, succinates, stearates, sulfanilate, subacetates, tartrates, theophyllineacetates, p-toluenesulfonates (tosylates), trifluoroacetates, terephthalates, tannates, teoclates, trihaloacetates, triethiodide, tricarboxylates, undecanoates and valerates.

In one embodiment, examples of inorganic salts of carboxylic acids or hydroxyls may be selected from ammonium, alkali metals to include lithium, sodium, potassium, cesium; alkaline earth metals to include calcium, magnesium, aluminium; zinc, barium, cholines, quaternary ammoniums.

In another embodiment, examples of organic salts of carboxylic acids or hydroxyl may be selected from arginine, organic amines to include aliphatic organic amines, alicyclic organic amines, aromatic organic amines, benzathines, t-butylamines, benethamines (N-benzylphenethylamine), dicyclohexylamines, dimethylamines, diethanolamines, ethanolamines, ethylenediamines, hydrabamines, imidazoles, lysines, methylamines, meglamines, N-methyl-D-glucamines, N,N′-dibenzylethylenediamines, nicotinamides, organic amines, ornithines, pyridines, picolies, piperazines, procain, tris(hydroxymethyl)methylamines, triethylamines, triethanolamines, trimethylamines, tromethamines and ureas.

In one embodiment, a natural plant compounds or metabolites thereof may be isolated from a plant or a part thereof. In another embodiment, cornuside may be isolated from plants selected from the group comprising species of the genus Cornus. In another embodiment, 2-(3,4-dihydroxyphenyl)-5-hydroxy-3,6,7-trimethoxy-4H-chromen-4-one may be isolated from plants selected from the group comprising species of the genus Teucrium. In another embodiment, isothymonin may be isolated from plants selected from the group comprising species of the genus Salvia. In another embodiment, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one may be isolated from plants selected from the group comprising species of the genus Spondias. In another embodiment, eupahakonenin B may be isolated from plants selected from the group comprising species of the genus Stevia. In another embodiment, a (E)-2-(3,7-dimethylocta-2,6-dien-1-yl)-5-pentylbenzene-1,3-diol may be isolated from plants selected from the group comprising species of the genus Cannabis.

In one embodiment, a natural plant compound or a metabolite thereof as described herein and used in the methods described herein comprises a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, a eupahakonenin B, or a (E)-2-(3,7-dimethylocta-2,6-dien-1-yl)-5-pentylbenzene-1,3-diol.

In another embodiment, the cornuside, 2-(3,4-dihydroxyphenyl)-5-hydroxy-3,6,7-trimethoxy-4H-chromen-4-one, isothymonin, 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, eupahakonenin B, or (E)-2-(3,7-dimethylocta-2,6-dien-1-yl)-5-pentylbenzene-1,3-diol comprised in compositions described herein and applied in methods described herein, is an isolated compound. In another embodiment, the cornuside, 2-(3,4-dihydroxyphenyl)-5-hydroxy-3,6,7-trimethoxy-4H-chromen-4-one, isothymonin, 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, eupahakonenin B, or (E)-2-(3,7-dimethylocta-2,6-dien-1-yl)-5-pentylbenzene-1,3-diol is applied as part of a composition.

In one embodiment, a composition comprising a cornuside, 2-(3,4-dihydroxyphenyl)-5-hydroxy-3,6,7-trimethoxy-4H-chromen-4-one, isothymonin, 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, eupahakonenin B, or (E)-2-(3,7-dimethylocta-2,6-dien-1-yl)-5-pentylbenzene-1,3-diol is made using a cornuside, 2-(3,4-dihydroxyphenyl)-5-hydroxy-3,6,7-trimethoxy-4H-chromen-4-one, isothymonin, 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, eupahakonenin B, or (E)-2-(3,7-dimethylocta-2,6-dien-1-yl)-5-pentylbenzene-1,3-diol containing plant extract, respectively. In another embodiment, a cornuside, 2-(3,4-dihydroxyphenyl)-5-hydroxy-3,6,7-trimethoxy-4H-chromen-4-one, isothymonin, 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, eupahakonenin B, or (E)-2-(3,7-dimethylocta-2,6-dien-1-yl)-5-pentylbenzene-1,3-diol is extracted from a plant or a part thereof, and used directly or comprised in a composition.

In another embodiment, the cornuside may be extracted from plants selected from the group comprising plants of the genus Cornus. In a further embodiment, additional compounds having beneficial properties may be extracted from plants of the genus Cornus. In yet a further embodiment, compositions described herein may comprise a combination of said cornuside or metabolite thereof, and any other active compound extracted from plants of the genus Cornus. In another embodiment, the 2-(3,4-dihydroxyphenyl)-5-hydroxy-3,6,7-trimethoxy-4H-chromen-4-one may be extracted from plants selected from the group comprising plants of the genus Teucrium. In a further embodiment, additional compounds having beneficial properties may be extracted from plants of the genus Teucrium. In yet a further embodiment, compositions described herein may comprise a combination of said 2-(3,4-dihydroxyphenyl)-5-hydroxy-3,6,7-trimethoxy-4H-chromen-4-one or metabolite thereof, and any other active compound extracted from plants of the genus Teucrium. In another embodiment, the isothymonin may be extracted from plants selected from the group comprising plants of the genus Salvia. In a further embodiment, additional compounds having beneficial properties may be extracted from plants of the genus Salvia. In yet a further embodiment, compositions described herein may comprise a combination of said isothymonin or metabolite thereof, and any other active compound extracted from plants of the genus Salvia. In another embodiment, the 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one may be extracted from plants selected from the group comprising plants of the genus Spondias. In a further embodiment, additional compounds having beneficial properties may be extracted from plants of the genus Spondias. In yet a further embodiment, compositions described herein may comprise a combination of said 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one or metabolite thereof, and any other active compound extracted from plants of the genus Spondias. In another embodiment, the eupahakonenin B may be extracted from plants selected from the group comprising plants of the genus Stevia. In a further embodiment, additional compounds having inhibitory properties may be extracted from plants of the genus Stevia. In yet a further embodiment, compositions described herein may comprise a combination of said eupahakonenin B or metabolite thereof, and any other active compound extracted from plants of the genus Stevia. In another embodiment, the (E)-2-(3,7-dimethylocta-2,6-dien-1-yl)-5-pentylbenzene-1,3-diol may be extracted from plants selected from the group comprising plants of the genus Cannabis. In a further embodiment, additional compounds having inhibitory properties may be extracted from plants of the genus Cannabis. In yet a further embodiment, compositions described herein may comprise a combination of said (E)-2-(3,7-dimethylocta-2,6-dien-1-yl)-5-pentylbenzene-1,3-diol or metabolite thereof, and any other active compound extracted from plants of the genus Cannabis.

A skilled artisan would appreciate that the term “extract” may encompass in one embodiment, a preparation obtained by concentrating a solution resulting from the depletion of a plant substance by a solvent. In one embodiment a solvent is water. In another embodiment a solvent is an organic solvent. In some embodiments, an extract described herein refers to the compound of extracting a plant material for a sufficient period of time (typically 1-48 hours), temperature (typically 0-100° C.) with a suitable solvent, typically an organic solvent, carbon dioxide, and water, or mixtures of such solvents with each other. Typical organic solvents are polyhydric alcohols (e.g. glycerol, polyethylene glycol, propylene glycol), alcohols (e.g. methanol, ethanol, butanol, propanol), hydrocarbons (e.g. hexane, benzene, pentane, toluene, xylene), halogenated hydrocarbons (e.g. chloroform, dichloromethane), ethers (e.g. diethyl ethers, tetrahydrofuran), esters (e.g. ethyl acetate, isopropyl myristate). In another embodiment, an organic extract is a supercritical carbon dioxide extract. An extract may be obtained by combinations of these solvents with water (typically at ratio of 0.5% to 90%).

In one embodiment, a period of extraction is about 1 hour. In another embodiment, a period of extraction is about 2 hours, 3 hours, 4 hours, 5 hours, 6 hours, 7 hours, 8 hours, 9 hours, 10 hours, 11 hours, 12 hours, 13 hours, 14 hours, 15 hours, 16 hours, 17 hours, 18 hours, 19 hours, 20 hours, 21 hours, 24 hours, 25 hours, 26 hours, 27 hours, 28 hours, 29 hours, 30 hours, 31 hours, 32 hours, 33 hours, 34 hours, 35 hours, 36 hours, 37 hours, 38 hours, 39 hours, 40 hours, 41 hours, 42 hours, 43 hours, 44 hours, 45 hours, 46 hours, 47 hours, or 48 hours. In another embodiment, a period of extraction is less than 12 hours. In another embodiment, a period of extraction is more than 12 hours. In another embodiment, a period of extraction is less than 24 hours. In another embodiment, a period of extraction is more than 24 hours. In another embodiment, a period of extraction is less than 36 hours. In another embodiment, a period of extraction is more than 36 hours. In another embodiment, a period of extraction is less than 48 hours. In another embodiment, a period of extraction is more than 48 hours.

In one embodiment, a temperature range for extraction is between about 1-100° C. In another embodiment, a temperature range for extraction is between about 1-10° C. In another embodiment, a temperature range for extraction is between about 10-20° C. In another embodiment, a temperature range for extraction is between about 20-30° C. In another embodiment, a temperature range for extraction is between about 30-40° C. In another embodiment, a temperature range for extraction is between about 40-50° C. In another embodiment, a temperature range for extraction is between about 50-60° C. In another embodiment, a temperature range for extraction is between about 60-70° C. In another embodiment, a temperature range for extraction is between about 70-80° C. In another embodiment, a temperature range for extraction is between about 80-90° C. In another embodiment, a temperature range for extraction is between about 90-100° C. In another embodiment, extraction is performed at more than one temperature.

In one embodiment, an extract described herein comprises a powdered plant material, a seed oil, an essential oil or the compound of steam distillation. In each case the extract is derived from the same plant or a part thereof as the plant-derived active ingredient. In one embodiment, the plant extract is a homogeneous material. In another embodiment, an extract described herein is comprised in a composition. In another embodiment, a composition comprising an extract described herein is used in methods described herein.

In one embodiment, a plant extract is derived from a part of a plant, including but not limited to a stem, a stem bark, a trunk, a trunk bark, a twig, a tuber, a root, a root bark, a young shoot, a seed, a rhizome, a flower and other recompoundive organs, a leaf and other aerial parts, or any combination thereof. In certain embodiments, a plant-derived active ingredient and an extract from the same plant are each obtained from the same part of the plant. In alternate embodiments, a plant-derived active ingredient and an extract from the same plant are each obtained from different parts of the plant.

Independent of the method of making an extract, in certain embodiments, an extract described herein is stable and its synthesis reproducible.

In one embodiment, an extract may be fractionated using means well known in the art, for example column chromatography or high-throughput chromatography in order to separate activities, remove toxic elements, remove undesirable activities, or to concentrate an activity or activities, or any combination thereof. In one embodiment, an extract is a fraction of an extract. As used herein the term “fraction” refers in one embodiment to a group of components or class of structurally similar components having defined parameters such as solubility, molecular weight range, polarity range, adsorption coefficients, binding characteristics, chemical reactivity or selective solubility. In some embodiments, a fractions will be the compound of chromatographic separation techniques, i.e., flash chromatography, preparative high performance liquid chromatography (HPLC), preparative gas chromatography, preparative thin layer chromatography, affinity chromatography, size exclusion chromatography, liquid-liquid chromatography e. g., counter-current chromatography or centripetal chromatography.

In one embodiment, a natural plant compound or metabolite thereof, as described herein may be de novo synthesized or may be a synthetic analogue, or any mixtures thereof. In another embodiment, a natural plant compound or metabolite thereof, as described herein, may be obtained by synthetic methods, which in certain embodiments provide a flexible and low-cost method of preparation.

In another embodiment, a natural plant compound or metabolite thereof, as described herein, comprised in a composition herein and used in the methods described herein may be purchased from a chemical vendor, for example but not limited to ABI chem, Oakwood Compounds, 4C Pharma Scientific, Angene Chemical, AAA Chemistry, Zinc, Ambintor, eheterocycles LTD, Molport, AnalytiCon Discovery GmbH Germany, and Chemfrog. In another embodiment, a de novo synthesized a natural plant compound or metabolite thereof, as described herein, or a synthetic analog thereof, or a combination thereof, comprises a natural plant compound or metabolite thereof, as described herein, or its derivative, isomer, tautomer, hydrate, or salt, or a combination thereof.

In one embodiment, a natural plant compound or metabolite thereof, as described herein, may be a semi-synthetic variant, a synthetic variant, an isomer, a derivative, a metabolite, an analog, a derivative, a salt, a crystal, an N-oxide, a tautomer, or a hydrate, or any combination thereof. In another embodiment, a natural plant compound or metabolite thereof, as described herein, applied in methods described herein comprises a synthetic compound. In another embodiment, the a natural plant compound or metabolite thereof, as described herein applied in methods described herein, comprises a semi-synthetic compound. In another embodiment, the natural plant compound or metabolite thereof, as described herein, comprises an isomer, a derivative, a metabolite, an analog, a derivative, a salt, a crystal, an N-oxide, tautomer, or a hydrate, or any combination thereof.

In one embodiment, methods described herein apply a natural plant compound or metabolite thereof to a beneficial rhizobacteria. In another embodiment, methods described herein apply a cornuside to a beneficial rhizobacteria. In another embodiment, methods described herein apply a 2-(3,4-dihydroxyphenyl)-5-hydroxy-3,6,7-trimethoxy-4H-chromen-4-one to a beneficial rhizobacteria. In another embodiment, methods described herein apply an isothymonin to a beneficial rhizobacteria. In another embodiment, methods described herein apply a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one to a beneficial rhizobacteria. In another embodiment, methods described herein apply a semi-synthetic variant, a synthetic variant, an isomer, a metabolite, a salt, a polymorph, a crystal, an N-oxide, a tautomer, or a hydrate, or any combination thereof of a natural plant compound, wherein said compound comprises cornuside, a 2-(3,4-dihydroxyphenyl)-5-hydroxy-3,6,7-trimethoxy-4H-chromen-4-one, an isothymonin, or a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one.

In one embodiment, methods described herein apply a natural plant compound or metabolite thereof to a pathogenic bacterium. In another embodiment, methods described herein apply a eupahakonenin B to a pathogenic bacterium. In another embodiment, methods described herein apply a (E)-2-(3,7-dimethylocta-2,6-dien-1-yl)-5-pentylbenzene-1,3-diol to a pathogenic bacterium.

In another embodiment, methods described herein apply a semi-synthetic variant, a synthetic variant, an isomer, a metabolite, a salt, a polymorph, a crystal, an N-oxide, a tautomer, or a hydrate, or any combination thereof of a natural plant compound, wherein said compound comprises a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, a eupahakonenin B, or a (E)-2-(3,7-dimethylocta-2,6-dien-1-yl)-5-pentylbenzene-1,3-diol.

In one embodiment, methods described herein apply a natural plant compound or metabolite thereof to a portion of soil around a plant on which a biofilm may form, is being formed or has formed. In another embodiment, methods described herein apply a cornuside to a portion of soil around a plant on which a biofilm may form, is being formed or has formed. In another embodiment, methods described herein apply a 2-(3,4-dihydroxyphenyl)-5-hydroxy-3,6,7-trimethoxy-4H-chromen-4-one to a portion of soil around a plant on which a biofilm may form, is being formed or has formed. In another embodiment, methods described herein apply an isothymonin to a portion of soil around a plant on which a biofilm may form, is being formed or has formed. In another embodiment, methods described herein apply a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one to a portion of soil around a plant on which a biofilm may form, is being formed or has formed. In another embodiment, methods described herein apply a (E)-2-(3,7-dimethylocta-2,6-dien-1-yl)-5-pentylbenzene-1,3-diol to a portion of soil around a plant on which a biofilm may form, is being formed or has formed. In another embodiment, methods described herein apply a eupahakonenin B to a portion of soil around a plant on which a biofilm may form, is being formed or has formed. In another embodiment, methods described herein apply a semi-synthetic variant, a synthetic variant, an isomer, a metabolite, a salt, a polymorph, a crystal, an N-oxide, a tautomer, or a hydrate, or any combination thereof of a natural plant compound, wherein said compound comprises cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, or a (E)-2-(3,7-dimethylocta-2,6-dien-1-yl)-5-pentylbenzene-1,3-diol.

In one embodiment, methods described herein apply a semi-synthetic variant, a synthetic variant, an isomer, a metabolite, a salt, a polymorph, a crystal, an N-oxide, a tautomer or a hydrate, or any combination thereof of a natural plant compound or metabolite thereof to a portion of soil around a plant on which a biofilm may form, is being formed or has formed. In another embodiment, methods described herein apply a semi-synthetic variant, a synthetic variant, an isomer, a metabolite, a salt, a polymorph, a crystal, an N-oxide, a tautomer or a hydrate, or any combination thereof of cornuside to a portion of soil around a plant on which a biofilm may form, is being formed or has formed. In another embodiment, methods described herein apply a semi-synthetic variant, a synthetic variant, an isomer, a metabolite, a salt, a polymorph, a crystal, an N-oxide, a tautomer or a hydrate, or any combination thereof of 2-(3,4-dihydroxyphenyl)-5-hydroxy-3,6,7-trimethoxy-4H-chromen-4-one to a portion of soil around a plant on which a biofilm may form, is being formed or has formed. In another embodiment, methods described herein apply a semi-synthetic variant, a synthetic variant, an isomer, a metabolite, a salt, a polymorph, a crystal, an N-oxide, a tautomer or a hydrate, or any combination thereof of isothymonin to a portion of soil around a plant on which a biofilm may form, is being formed or has formed. In another embodiment, methods described herein apply a semi-synthetic variant, a synthetic variant, an isomer, a metabolite, a salt, a polymorph, a crystal, an N-oxide, a tautomer or a hydrate, or any combination thereof of 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one to a portion of soil around a plant on which a biofilm may form, is being formed or has formed. In another embodiment, methods described herein apply a semi-synthetic variant, a synthetic variant, an isomer, a metabolite, a salt, a polymorph, a crystal, an N-oxide, a tautomer or a hydrate, or any combination thereof, of a eupahakonenin B to a portion of soil around a plant on which a biofilm may form, is being formed or has formed. In another embodiment, methods described herein apply a semi-synthetic variant, a synthetic variant, an isomer, a metabolite, a salt, a polymorph, a crystal, an N-oxide, a tautomer or a hydrate, or any combination thereof, of a (E)-2-(3,7-dimethylocta-2,6-dien-1-yl)-5-pentylbenzene-1,3-diol to a portion of soil around a plant on which a biofilm may form, is being formed or has formed.

In one embodiment, a natural plant compound or a metabolite thereof is applied comprised in a composition. In another embodiment, a cornuside is applied comprised in a composition. In another embodiment, a 2-(3,4-dihydroxyphenyl)-5-hydroxy-3,6,7-trimethoxy-4H-chromen-4-one is applied comprised in a composition. In another embodiment, an isothymonin is applied comprised in a composition. In another embodiment, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one is applied comprised in a composition. In another embodiment, a (E)-2-(3,7-dimethylocta-2,6-dien-1-yl)-5-pentylbenzene-1,3-diol is applied comprised in a composition. In another embodiment, an eupahakonenin B is applied comprised in a composition.

In another embodiment, a composition comprising a natural plant compound or a metabolite thereof is applied in the form of a dry powder. In another embodiment, a composition comprising a cornuside is applied in the form of a dry powder. In another embodiment, a composition comprising a 2-(3,4-dihydroxyphenyl)-5-hydroxy-3,6,7-trimethoxy-4H-chromen-4-one is applied in the form of a dry powder. In another embodiment, a composition comprising an isothymonin is applied in the form of a dry powder. In another embodiment, a composition comprising a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one is applied in the form of a dry powder. In another embodiment, a composition comprising eupahakonenin B is applied in the form of a dry powder. In another embodiment, a composition comprising a compound of formula is applied in the form of a dry powder.

In another embodiment, a composition comprising a natural plant compound or a metabolite thereof is applied in the form of a solution. In another embodiment, a composition comprising a cornuside is applied in the form of a solution. In another embodiment, a composition comprising a 2-(3,4-dihydroxyphenyl)-5-hydroxy-3,6,7-trimethoxy-4H-chromen-4-one is applied in the form of a solution. In another embodiment, a composition comprising an isothymonin is applied in the form of a solution. In another embodiment, a composition comprising a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one is applied in the form of a solution. In another embodiment, a composition comprising eupahakonenin B is applied in the form of a solution. In another embodiment, a composition comprising a (E)-2-(3,7-dimethylocta-2,6-dien-1-yl)-5-pentylbenzene-1,3-diol is applied in the form of a solution. In another embodiment, a solution comprises an aqueous solution. In another embodiment, an aqueous solution comprises a PBS (Phosphate buffered Saline) solution.

In another embodiment, a composition comprising a natural plant compound or a metabolite thereof is applied in the form of an aqueous solution at pH 7. In another embodiment, a composition comprising a cornuside is applied in the form of an aqueous solution at pH 7. In another embodiment, a composition comprising a 2-(3,4-dihydroxyphenyl)-5-hydroxy-3,6,7-trimethoxy-4H-chromen-4-one is applied in the form of an aqueous solution at pH 7. In another embodiment, a composition comprising an isothymonin is applied in the form of an aqueous solution at pH 7. In another embodiment, a composition comprising a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one is applied in the form of an aqueous solution at pH 7. In another embodiment, a composition comprising eupahakonenin B is applied in the form of a aqueous solution at pH 7. In another embodiment, a composition comprising a (E)-2-(3,7-dimethylocta-2,6-dien-1-yl)-5-pentylbenzene-1,3-diol is applied in the form of an aqueous solution at pH 7.

In another embodiment, a composition comprising a natural plant compound or a metabolite thereof is applied in the form of a spray. In another embodiment, a composition comprising a cornuside is applied in the form of a spray. In another embodiment, a composition comprising a 2-(3,4-dihydroxyphenyl)-5-hydroxy-3,6,7-trimethoxy-4H-chromen-4-one is applied in the form of a spray. In another embodiment, a composition comprising an isothymonin is applied in the form of a spray. In another embodiment, a composition comprising a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one is applied in the form of a spray. In another embodiment, a composition comprising eupahakonenin B is applied in the form of a spray. In another embodiment, a composition comprising a (E)-2-(3,7-dimethylocta-2,6-dien-1-yl)-5-pentylbenzene-1,3-diol is applied in the form of a spray. In another embodiment, a spray comprises an aqueous spray. In another embodiment, an aqueous pray comprises a PBS (Phosphate buffered Saline) solution.

In another embodiment, a composition comprising a natural plant compound or a metabolite thereof is applied in the form of an aqueous spray at pH 7. In another embodiment, a composition comprising a cornuside is applied in the form of an aqueous spray at pH 7. In another embodiment, a composition comprising a 2-(3,4-dihydroxyphenyl)-5-hydroxy-3,6,7-trimethoxy-4H-chromen-4-one is applied in the form of an aqueous spray at pH 7. In another embodiment, a composition comprising an isothymonin is applied in the form of an aqueous spray at pH 7. In another embodiment, a composition comprising a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one is applied in the form of an aqueous spray. In another embodiment, a composition comprising eupahakonenin B is applied in the form of a aqueous spray at pH 7. In another embodiment, a composition comprising a (E)-2-(3,7-dimethylocta-2,6-dien-1-yl)-5-pentylbenzene-1,3-diol is applied in the form of an aqueous spray at pH 7.

In another embodiment, a composition comprising a natural plant compound or a metabolite thereof is applied in the form of a tablet. In another embodiment, a composition comprising a cornuside is applied in the form of a tablet. In another embodiment, a composition comprising a 2-(3,4-dihydroxyphenyl)-5-hydroxy-3,6,7-trimethoxy-4H-chromen-4-one is applied in the form of a tablet. In another embodiment, a composition comprising an isothymonin is applied in the form of a tablet. In another embodiment, a composition comprising a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one is applied in the form of a tablet. In another embodiment, a composition comprising eupahakonenin B is applied in the form of a tablet. In another embodiment, a composition comprising a (E)-2-(3,7-dimethylocta-2,6-dien-1-yl)-5-pentylbenzene-1,3-diol is applied in the form of a tablet.

In another embodiment, a composition comprising a natural plant compound or a metabolite thereof is applied in the form of a paste. In another embodiment, a composition comprising a cornuside is applied in the form of a paste. In another embodiment, a composition comprising a 2-(3,4-dihydroxyphenyl)-5-hydroxy-3,6,7-trimethoxy-4H-chromen-4-one is applied in the form of a paste. In another embodiment, a composition comprising an isothymonin is applied in the form of a paste. In another embodiment, a composition comprising a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one is applied in the form of a paste. In another embodiment, a composition comprising eupahakonenin B is applied in the form of a paste. In another embodiment, a composition comprising a (E)-2-(3,7-dimethylocta-2,6-dien-1-yl)-5-pentylbenzene-1,3-diol is applied in the form of a paste.

In another embodiment, a composition comprising a natural plant compound or a metabolite thereof is applied in the form of drops. In another embodiment, a composition comprising a cornuside is applied in the form of drops. In another embodiment, a composition comprising a 4′,5, 6-Trihydroxy-3′,5′,7-trimethoxyflavone is applied in the form of drops. In another embodiment, a composition comprising an isothymonin is applied in the form of drops. In another embodiment, a composition comprising a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one is applied in the form of drops. In another embodiment, a composition comprising eupahakonenin B is applied in the form of drops. In another embodiment, a composition comprising a (E)-2-(3,7-dimethylocta-2,6-dien-1-yl)-5-pentylbenzene-1,3-diol is applied in the form of drops.

In one embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 0.001 ppm 5 ppm. In another embodiment, a composition described herein comprises an aqueous solution comprising a natural plant compound or a metabolite thereof, wherein said natural plant compound is selected from the group comprising a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 0.01 ppm 2.5 ppm. In another embodiment, a composition described herein comprises a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol aqueous solution at about 0.1 ppm-2.0 ppm. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 1.0 ppm 2.0 ppm. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 0.001 ppm. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 0.001 ppm. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 0.1 ppm. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 0.5 ppm. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 1 ppm. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 2 ppm. In another embodiment, a composition described herein comprises an solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 3 ppm. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 4 ppm. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 5 ppm.

In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 0.001 mM-100 mM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 0.1 μM-10 μM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 0.1 μM-1.0 μM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 1 μM-2 μM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 1 μM-5 μM.

In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 1 μM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 2 μM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 1 μM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 3 μM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 1 μM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 4 μM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 1 μM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 5 μM.

In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 0.01 mM-100 mM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 0.1 mM-100 mM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 1.0 mM-100 mM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 1.0 mM-50 mM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 5 mM-40 mM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 10 mM-30 mM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 10 mM-50 mM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 1 mM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 5 mM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 10 mM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 20 mM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 25 mM. In another embodiment, a composition described herein comprises a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 30 mM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 35 mM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 40 mM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 45 mM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 50 mM.

In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 0.0001 μM-1000 μM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 0.001 μM-1000 In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 0.01 μM-100 μM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 0.1 μM-100 μM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 0.1 μM-10 μM.

In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 1.0 μM-100 μM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 1.0 μM-50 μM.

In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 1 μM-75 μM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 25 μM-50 μM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 5 μM-40 μM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 10 μM-30 μM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 10 μM-50 μM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 1 μM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 5 μM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 10 μM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 20 μM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 25 μM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 30 μM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 35 μM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 40 μM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 45 μM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 50 μM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 60 μM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 70 μM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 80 μM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 90 μM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 100 μM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 200 μM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 250 μM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 500 μM.

In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 0.0001 nM-1000 nM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 0.001 nM-1000 nM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 0.01 nM-100 nM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 0.1 nM-100 nM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 0.1 nM-10 nM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 1.0 nM-100 nM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 1.0 nM-50 nM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 1 nM-75 nM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 25 nM-50 nM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 5 nM-40 nM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 10 nM-30 nM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 10 nM-50 nM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 1 nM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 5 nM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 10 nM.

In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 20 nM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 25 nM.

In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 30 nM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 35 nM.

In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 40 nM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 45 nM.

In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 50 nM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol about 60 nM

In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 70 nM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 80 nM.

In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 90 nM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one an eupahakonenin B, and a (E)-2-(3,7-dimethylocta-2,6-dien-1-yl)-5-pentylbenzene-1,3-diol, about 100 nM.

In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 200 nM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 250 nM. In another embodiment, a composition described herein comprises an aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 500 nM.

In one embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 0.001 ppm 5 ppm. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 0.01 ppm 2.5 ppm. In another embodiment, a composition described herein comprises a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol aqueous solution at about 0.1 ppm 2.0 ppm. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 1.0 ppm 2.0 ppm. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 0.001 ppm. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 0.001 ppm. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 0.1 ppm. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 0.5 ppm. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 1 ppm. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 2 ppm. In another embodiment, a composition described herein comprises an solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 3 ppm. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 4 ppm. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 5 ppm.

In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 0.001 mM-100 mM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 0.1 M-10 μM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 0.1 μM-1.0 μM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 1 μM-2 μM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 1 μM-5 μM.

In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 1 μM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 2 μM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 1 μM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 3 μM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 1 μM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 4 μM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 1 μM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 5 μM.

In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 0.01 mM-100 mM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 0.1 mM-100 mM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 1.0 mM-100 mM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 1.0 mM-50 mM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 5 mM-40 mM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 10 mM-30 mM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 10 mM-50 mM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 1 mM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 5 mM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 10 mM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 20 mM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 25 mM. In another embodiment, a composition described herein comprises a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol aqueous solution comprising a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 30 mM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 35 mM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 40 mM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 45 mM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol at about 50 mM.

In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 0.0001 μM-1000 In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 0.001 μM-1000 μM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 0.01 μM-100 μM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 0.1 μM-100 μM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 0.1 μM-10 μM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 1.0 μM-100 μM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 1.0 μM-50 μM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 1 μM-75 μM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 25 μM-50 μM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 5 μM-40 μM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 10 μM-30 μM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 10 μM-50 μM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 1 μM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 5 μM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 10 μM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 20 μM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 25 μM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 30_{μ}M. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 35_{μ}M. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 40 μM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 45 μM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 50 μM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 60 μM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 70 μM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 80 μM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 90 μM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 100 μM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 200 μM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 250 μM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 500 μM.

In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 0.0001 nM-1000 nM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 0.001 nM-1000 nM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 0.01 nM-100 nM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 0.1 nM-100 nM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 0.1 nM-10 nM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 1.0 nM-100 nM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 1.0 nM-50 nM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 1 nM-75 nM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 25 nM-50 nM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 5 nM-40 nM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 10 nM-30 nM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 10 nM-50 nM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 1 nM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 5 nM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 10 nM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 20 nM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 25 nM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 30 nM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 35 nM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 40 nM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 45 nM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 50 nM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol about 60 nM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 70 nM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 80 nM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 90 nM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one an eupahakonenin B, and a (E)-2-(3,7-dimethylocta-2,6-dien-1-yl)-5-pentylbenzene-1,3-diol, about 100 nM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 200 nM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 250 nM. In another embodiment, a composition described herein comprises a natural plant compound or a metabolite thereof, wherein said natural plant compound is selected from the group comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, and a (E)-2-(3,7-dimethylocta-2,6-dien-1-yl)-5-pentylbenzene-1,3-diol, about 500 nM.

### Applications/Formulations

In one embodiment, application of a composition described herein comprises applying a composition comprising nanomolar (nM) quantities a natural plant compound or a metabolite thereof selected from the group comprising a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, as described herein comprising to the roots of a plant, in combination with Bacillus spores. In an alternative embodiment, application of a composition described herein comprises applying micromolar (μM) quantities of a natural plant compound or a metabolite thereof selected from the group comprising a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, described herein to the roots of a plant, prior to application of Bacillus spores. In yet a further embodiment, application of a composition described herein comprises applying a composition comprising micromolar (μM) quantities of a natural plant compound or a metabolite thereof selected from the group comprising a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, described herein, to a portion of soil surrounding a plant. In another embodiment, application to the portion of soil, promotes natural colonization by Bacillus species.

In another embodiment, application comprises applying a composition comprising nanomolar (nM) quantities of a natural plant compound or a metabolite thereof selected from the group comprising a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one to the roots of a plant in combination with spores of a beneficial rhizobacteria. In another embodiment, application comprises applying a composition comprising nanomolar (nM) quantities of a natural plant compound or a metabolite thereof selected from the group comprising a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one to the roots of a plant in combination with spores of a Bacillus species.

In another embodiment, application comprises applying a composition comprising micromolar (μM) quantities of a natural plant compound or a metabolite thereof selected from the group comprising a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one to the roots of a plant prior to application of spores of a beneficial rhizobacteria. In another embodiment, application comprises applying a composition comprising micromolar (μM) quantities of a natural plant compound or a metabolite thereof selected from the group comprising a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one to the roots of a plant prior to application of spores of a Bacillus species.

In another embodiment, application comprises applying a composition comprising micromolar (μM) quantities of a natural plant compound or a metabolite thereof selected from the group comprising a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one to an area of soil around a plant. In another embodiment, application comprises applying a composition comprising micromolar (μM) quantities of a natural plant compound or a metabolite thereof selected from the group comprising a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one to an area of soil around a plant root. In another embodiment, application to the portion of soil, promotes natural colonization by Bacillus species. It will be understood by those skilled in the art that a composition applied to an area of soil may seep into the soil over time.

In one embodiment, application of a composition described herein comprises applying a composition comprising nanomolar (nM) quantities a natural plant compound or a metabolite thereof selected from the group comprising a eupahakonenin B and a (E)-2-(3,7-dimethylocta-2,6-dien-1-yl)-5-pentylbenzene-1,3-diol, as described herein to a biofilm on the roots of a plant. In another embodiment, application of a composition described herein comprises applying a composition comprising micromolar μM) quantities a natural plant compound or a metabolite thereof selected from the group comprising a eupahakonenin B and a (E)-2-(3,7-dimethylocta-2,6-dien-1-yl)-5-pentylbenzene-1,3-diol, as described herein to a biofilm on the roots of a plant. In another embodiment, application of a composition described herein comprises applying a composition comprising nanomolar (nM) quantities a natural plant compound or a metabolite thereof selected from the group comprising a eupahakonenin B and a (E)-2-(3,7-dimethylocta-2,6-dien-1-yl)-5-pentylbenzene-1,3-diol, as described herein to a biofilm on a non-root portion of a plant. In another embodiment, application of a composition described herein comprises applying a composition comprising micromolar μM) quantities a natural plant compound or a metabolite thereof selected from the group comprising a eupahakonenin B and a (E)-2-(3,7-dimethylocta-2,6-dien-1-yl)-5-pentylbenzene-1,3-diol, as described herein to a biofilm on a non-root portion of a plant. In another embodiment, application inhibits biofilm formation on the plant or the plant root by a plant pathogen. In another embodiment, application inhibits pellicle formation on the plant or plant root by a plant pathogen.

In still a further embodiment, application of a composition described herein comprises applying a composition comprising nanomolar (nM) quantities of a natural plant compound or a metabolite thereof selected from the group a eupahakonenin B and a (E)-2-(3,7-dimethylocta-2,6-dien-1-yl)-5-pentylbenzene-1,3-diol, described herein, to a portion of soil surrounding a plant. In yet a further embodiment, application of a composition described herein comprises applying a composition comprising micromolar (μM) quantities of a natural plant compound or a metabolite thereof selected from the group a eupahakonenin B and a (E)-2-(3,7-dimethylocta-2,6-dien-1-yl)-5-pentylbenzene-1,3-diol, described herein, to a portion of soil surrounding a plant. It will be understood by those skilled in the art that a composition applied to an area of soil may seep into the soil over time. In another embodiment, application to the portion of soil, inhibits biofilm formation on a plant or a plant root by a plant pathogen. In another embodiment, application to the portion of soil, inhibits pellicle formation on the plant or plant root by a plant pathogen.

In one embodiment, application is for about 1-24 hours. In another embodiment, application is for about 1-12 hours. In another embodiment, application is for about 12-24 hours. In another embodiment, application is for about 5-10 hours. In another embodiment, application is for about 1 hour. In another embodiment, application is for about 2 hours. In another embodiment, application is for about 3 hours. In another embodiment, application is for about 4 hours. In another embodiment, application is for about 5 hours. In another embodiment, application is for about 6 hours. In another embodiment, application is for about 7 hours. In another embodiment, application is for about 8 hours. In another embodiment, application is for about 9 hours. In another embodiment, application is for about 10 hours. In another embodiment, application is for about 11 hours. In another embodiment, application is for about 12 hours. In another embodiment, application is for about 20 hours. In another embodiment, application is for about 24 hours. In another embodiment, application is for less than 1 hour. In another embodiment, application is for more than 24 hours.

Compositions containing a natural plant compound or a metabolite thereof selected from the group comprising a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, or their isomer, tautomer, hydrate, or salt, or a combination thereof, may be used to induce, enhance, and enhance biofilm formation on a surface of a plant or a part thereof. Such a surface can be any surface that may be prone to biofilm formation and adhesion of bacteria. Non-limiting examples of surfaces include aerial plant parts, plant vasculature, plant roots, and plant root hairs. In another embodiment, a surface of a plant is a plant root surface. In another embodiment, a surface of a plant is a plant root hair surface. In another embodiment, a surface of a plant is a vasculature surface. In another embodiment, a surface of a plant is an aerial surface, for example a leaf, a flower, or a stem. In another embodiment, a surface of a plant is below ground.

Compositions containing a natural plant compound or a metabolite thereof selected from the group a eupahakonenin B and a (E)-2-(3,7-dimethylocta-2,6-dien-1-yl)-5-pentylbenzene-1,3-diol, or their isomer, tautomer, hydrate, or salt, or a combination thereof, may be used to inhibit biofilm formation on a surface of a plant or a part thereof. In another embodiment, compositions containing a natural plant compound or a metabolite thereof selected from the group a eupahakonenin B and a (E)-2-(3,7-dimethylocta-2,6-dien-1-yl)-5-pentylbenzene-1,3-diol, or their isomer, tautomer, hydrate, or salt, or a combination thereof, may be used to inhibit pellicle formation on a surface of a plant or a part thereof. In another embodiment, compositions containing a natural plant compound or a metabolite thereof selected from the group a eupahakonenin B and a (E)-2-(3,7-dimethylocta-2,6-dien-1-yl)-5-pentylbenzene-1,3-diol, or their isomer, tautomer, hydrate, or salt, or a combination thereof, may be used to inhibit attachment of a plant pathogen to a surface of a plant or a part thereof. In another embodiment, compositions containing a natural plant compound or a metabolite thereof selected from the group a eupahakonenin B and a (E)-2-(3,7-dimethylocta-2,6-dien-1-yl)-5-pentylbenzene-1,3-diol, or their isomer, tautomer, hydrate, or salt, or a combination thereof, may be used to inhibit attachment of a plant pathogen to a surface of a biofilm that is on a surface of a plant or a part thereof. Such a surface can be any surface that may be prone to biofilm formation and adhesion of bacteria. Non-limiting examples of surfaces include aerial plant parts, plant vasculature, plant roots, and plant root hairs. In another embodiment, a surface of a plant is a plant root surface. In another embodiment, a surface of a plant is a plant root hair surface. In another embodiment, a surface of a plant is a vasculature surface. In another embodiment, a surface of a plant is an aerial surface, for example a leaf, a flower, or a stem. In another embodiment, a surface of a plant is below ground.

It will be understood by those skilled in the art that the term “surface” as used herein refers in one embodiment to the outside part or layer of a plant or a part thereof. In one embodiment, a biofilm described herein adheres to a plant surface, for example a root surface. In another embodiment, a biofilm described herein adheres to 100% of a surface, for example adheres to the complete root surface. In another embodiment, a biofilm adheres to less than 100% of a surface. In another embodiment, a biofilm adheres to less than 90% of a surface. In another embodiment, a biofilm adheres to less than 80% of a surface. In another embodiment, a biofilm adheres to less than 70% of a surface. In another embodiment, a biofilm adheres to less than 60% of a surface. In another embodiment, a biofilm adheres to less than 50% of a surface. In another embodiment, a biofilm adheres to less than 40% of a surface. In another embodiment, a biofilm adheres to less than 30% of a surface. In another embodiment, a biofilm adheres to less than 20% of a surface. In another embodiment, a biofilm adheres to less than 10% of a surface.

In one embodiment, provided herein is a method for inducing biofilm formation by a beneficial rhizobacteria on a plant or a part thereof, the method comprising the step of applying a composition comprising an effective amount of a natural plant compound or a metabolite thereof selected from the group comprising a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, described herein to the beneficial rhizobacteria or spores thereof, thereby inducing said biofilm formation. In another embodiment, the beneficial rhizobacteria or spores thereof are adhered to the plant or the part thereof. In another embodiment, the beneficial rhizobacteria or spores thereof are present in soil around the plant.

In one embodiment, provided herein is a method for inhibiting biofilm or pellicle formation by a pathogenic bacteria on a plant or a part thereof, the method comprising the step of applying a composition comprising an effective amount of a natural plant compound or a metabolite thereof selected from the group a eupahakonenin B and a (E)-2-(3,7-dimethylocta-2,6-dien-1-yl)-5-pentylbenzene-1,3-diol, described herein to the biofilm, pathogenic bacteria, or spores thereof, thereby inhibiting said biofilm or said pellicle formation. In one embodiment, provided herein is a method for inhibiting attachment of a pathogenic bacteria to a biofilm on plant or a part thereof, the method comprising the step of applying a composition comprising an effective amount of a natural plant compound or a metabolite thereof selected from the group a eupahakonenin B and a (E)-2-(3,7-dimethylocta-2,6-dien-1-yl)-5-pentylbenzene-1,3-diol, described herein to the biofilm, a pathogenic bacteria, or spores thereof, thereby inhibiting said biofilm formation or said pellicle formation. In another embodiment, the pathogenic bacteria or spores thereof were adhered to the plant or the part thereof. In another embodiment, the pathogenic bacteria or spores thereof are present in soil around the plant.

Importantly bacterial spores are frequently spread in natural settings. In another embodiment, beneficial rhizobacteria are present in the soil around a plant at about a distance of about up to several mms from a plant or a plant root. In another embodiment, beneficial rhizobacteria are present in the soil around a plant or a plant root at about a distance of about up to 100 mms from a plant or a plant root. In another embodiment, beneficial rhizobacteria are present in the soil around a plant or a plant root at about a distance of about up to 50 mms from a plant or a plant root. In another embodiment, beneficial rhizobacteria are present in the soil around a plant or a plant root at about a distance of about up to 40 mms from a plant or a plant root. In another embodiment, beneficial rhizobacteria are present in the soil around a plant or a plant root at about a distance of about up to 30 mms from a plant or a plant root. In another embodiment, beneficial rhizobacteria are present in the soil around a plant or a plant root at about a distance of about up to 20 mms from a plant or a plant root. In another embodiment, beneficial rhizobacteria are present in the soil around a plant or a plant root at about a distance of about 10-100 mms from a plant or a plant root. In another embodiment, beneficial rhizobacteria are present in the soil around a plant or a plant root at about a distance of about up to 10 mms from a plant or a plant root. In another embodiment, beneficial rhizobacteria are present in the soil around a plant or a plant root at about a distance of about 0-10 mms from a plant or a plant root. In another embodiment, beneficial rhizobacteria are present in the soil around a plant or a plant root at about a distance of about 0-5 mms from a plant or a plant root. In another embodiment, beneficial rhizobacteria are present in the soil around a plant or a plant root at about a distance of about up to 5 mms from a plant or a plant root. In another embodiment, beneficial rhizobacteria are present in the soil around a plant or a plant root at about a distance of about up to 1 mm from a plant or a plant root.

In another embodiment, beneficial rhizobacteria spores are present in the soil around a plant at about a distance of about up to several mms from a plant or a plant root. In another embodiment, beneficial rhizobacteria spores are present in the soil around a plant or a plant root at about a distance of about up to 10 mms from a plant or a plant root. In another embodiment, beneficial rhizobacteria spores are present in the soil around a plant or a plant root at about a distance of about up to 100 mms from a plant or a plant root. In another embodiment, beneficial rhizobacteria spores are present in the soil around a plant or a plant root at about a distance of about up to 50 mms from a plant or a plant root. In another embodiment, beneficial rhizobacteria spores are present in the soil around a plant or a plant root at about a distance of about up to 25 mms from a plant or a plant root. In another embodiment, beneficial rhizobacteria spores are present in the soil around a plant or a plant root at about a distance of about up to 5 mms from a plant or a plant root. In another embodiment, beneficial rhizobacteria spores are present in the soil around a plant or a plant root at about a distance of about up to 1-2 mms from a plant or a plant root. In another embodiment, beneficial rhizobacteria spores are present in the soil around a plant or a plant root at about a distance of about up to 0-2 mms from a plant or a plant root. In another embodiment, beneficial rhizobacteria spores are present in the soil around a plant or a plant root at about a distance of about up to 0-1 mms from a plant or a plant root. In another embodiment, beneficial rhizobacteria, or spores thereof, or any combination thereof, are present in the soil around a plant root at about a distance of about up to several mms from a plant. In another embodiment, beneficial rhizobacteria, or spores thereof, or any combination thereof, are present in the soil around a plant root at about a distance of about up to 10 mms from a plant.

In yet another embodiment, the beneficial rhizobacteria is adhered to the plant or part thereof, and is present in soil around the plant or a part thereof, for example around the root of the plant. In another embodiment, the beneficial rhizobacteria is not adhered to the plant or the part thereof. In another embodiment, the beneficial rhizobacteria is not present in soil around the plant. In another embodiment, the beneficial rhizobacteria is cultured in vitro, wherein said composition comprising a natural plant compound or a metabolite thereof selected from the group comprising a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, described herein is applied to the bacteria in vitro. In another embodiment, a method for inducing biofilm formation on a plant or a part thereof, further comprises the step of contacting said plant or part thereof with said beneficial rhizobacteria previously contacted with a composition presented herein. In another embodiment, a method for inducing biofilm formation on a plant or a part thereof, further comprises the step of contacting a soil portion around said plant with said beneficial rhizobacteria previously contacted with a composition presented herein.

As used herein, the term “inducing” refers in one embodiment to causing biofilm formation. In another embodiment, a method of inducing biofilm formation comprises a beneficial rhizobacteria colonizing a plant root and forming a biofilm. In another embodiment, inducing biofilm formation comprises beneficial rhizobacteria first colonizing a plant root and then forming a biofilm. In another embodiment, inducing biofilm formation comprises beneficial rhizobacteria simultaneously colonizing a plant root and forming a biofilm. In another embodiment, a method of inducing a biofilm comprises formation of an extracellular matrix that holds cells together. In another embodiment, the extracellular matrix comprises polysaccharide biopolymers. In another embodiment, a method of inducing biofilm formation comprises inducing secretion by the rhizobacteria of polymers, for example polysaccharides EPS, or poly-6-glutamate (PGA), or any combination thereof. In another embodiment, a method of inducing biofilm formation comprises inducing secretion by the rhizobacteria of a protein or proteins, for example TasA In another embodiment, a method of inducing biofilm formation comprises inducing secretion by the rhizobacteria of polymers, for example polysaccharides EPS, or poly-6-glutamate (PGA), or any combination thereof. In another embodiment, a method of inducing biofilm formation comprises inducing secretion by the rhizobacteria of a protein or proteins, for example TasA In another embodiment, a method of inducing biofilm formation comprises increasing secretion by the rhizobacteria of polymers, for example polysaccharides EPS, or poly-6-glutamate (PGA), or any combination thereof. In another embodiment, a method of inducing biofilm formation comprises increasing secretion by the rhizobacteria of a protein or proteins, for example TasA. In another embodiment, a method of inducing biofilm formation occurs where no biofilm is currently present. In another embodiment, a method of inducing biofilm formation occurs at the site of an already established biofilm. In another embodiment, a method of inducing biofilm formation decreases repression of matrix encoding operons, for example epsA-O operon and yqxM/tapA-sipW-tasA operon. In another embodiment, a method of inducing biofilm formation comprises enhancing the transcription of sinI. In another embodiment, induction of biofilm formation provides a beneficial effect to the plant. In another embodiment, induction of biofilm formation promotes plant growth.

In another embodiment, a method for inducing biofilm formation on a plant or a part thereof comprises the step of applying an effective amount of a composition comprising a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, described herein, to a B. subtilis species. In another embodiment, a method for enhancing biofilm formation on a plant or a part thereof, comprises the step of applying a composition comprising an effective amount of a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, described herein, to a B. subtilis species. In another embodiment, a method for maintaining a biofilm formation on a plant or a part thereof comprises the step of applying a composition comprising an effective amount of a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, described herein, to a B. subtilis species. In another embodiment, the B. subtilis species is B. subtilis FB17. In another embodiment, a I species is B. subtilis NCIB3610. In yet another embodiment, a B. subtilis species is B. subtilis RO-FF-1. In still another embodiment, a B. subtilis species is B. subtilis JH642.

In one embodiment, provided herein is a method for enhancing biofilm formation by a beneficial rhizobacteria on a plant or a part thereof, the method comprising the step of applying a composition comprising an effective amount of a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, described herein, to the beneficial rhizobacteria, thereby enhancing biofilm formation. In another embodiment, the beneficial rhizobacteria is adhered to the plant or the part thereof. In another embodiment, the beneficial rhizobacteria is present in soil around the plant. In yet another embodiment, the beneficial rhizobacteria is adhered to the plant or part thereof, and is present in soil around the plant. In another embodiment, the beneficial rhizobacteria is not adhered to the plant or the part thereof. In another embodiment, the beneficial rhizobacteria is not present in soil around the plant. In another embodiment, the beneficial rhizobacteria is cultured in vitro, wherein said composition comprising a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, described herein, is applied to the bacteria in vitro. In another embodiment, a method for enhancing biofilm formation on a plant or a part thereof, further comprises the step of contacting said plant or part thereof with said beneficial rhizobacteria previously contacted with a composition described herein. In another embodiment, a method for enhancing biofilm formation on a plant or a part thereof, further comprises the step of contacting a portion of soil around said plant or part thereof with said beneficial rhizobacteria previously contacted with a composition described herein.

As used herein, the term “enhancing” refers in one embodiment to increasing formation of a biofilm or improving formation of a biofilm. In another embodiment, a method of enhancing biofilm formation comprises increasing the rate of biofilm formation. In another embodiment, a method of enhancing biofilm formation comprises improving the colonization of a beneficial rhizobacteria associated with a plant, for example with a plant root, a plant root hair, or any combination thereof. In another embodiment, a method of enhancing biofilm formation comprises improving the biofilm formation, for example by improving adhesion of a beneficial rhizobacteria with a plant, for example a plant root, root hair or any combination thereof. In another embodiment, a method of enhancing biofilm formation comprises improving the biofilm formation, for example altering the matrix components. In another embodiment, a method of enhancing biofilm formation comprises improving the properties of a biofilm, for example improved resistance to infection, or improved resistance to pathogens, or any combination thereof.

In another embodiment, a method of enhancing biofilm formation comprises enhancing beneficial rhizobacteria colonizing a plant root. In another embodiment, enhancing biofilm formation comprises enhancing beneficial rhizobacteria colonizing a plant root and then forming a biofilm. In another embodiment, enhancing biofilm formation comprises enhancing simultaneously beneficial rhizobacteria colonizing a plant root and formation of a biofilm. In another embodiment, a method of enhancing a biofilm comprises enhancing formation of an extracellular matrix that holds cells together. In another embodiment, the extracellular matrix comprises polysaccharide biopolymers. In another embodiment, a method of enhancing biofilm formation comprises inducing secretion by the rhizobacteria of polymers, for example polysaccharides EPS, or poly-6-glutamate (PGA), or any combination thereof. In another embodiment, a method of enhancing biofilm formation comprises inducing secretion by the rhizobacteria of a protein or proteins, for example TasA In another embodiment, a method of enhancing biofilm formation comprises enhancing secretion by the rhizobacteria of polymers, for example polysaccharides EPS, or poly-6-glutamate (PGA), or any combination thereof. In another embodiment, a method of enhancing biofilm formation comprises enhancing secretion by the rhizobacteria of a protein or proteins, for example TasA In another embodiment, a method of enhancing biofilm formation comprises increasing secretion by the rhizobacteria of polymers, for example polysaccharides EPS, or poly-6-glutamate (PGA), or any combination thereof. In another embodiment, a method of enhancing biofilm formation comprises increasing secretion by the rhizobacteria of a protein or proteins, for example TasA. In another embodiment, a method of enhancing biofilm formation occurs where no biofilm is currently present. In another embodiment, a method of enhancing biofilm formation occurs at the site of an already established biofilm. In another embodiment, enhancing biofilm formation provides a beneficial effect to the plant.

In one embodiment, provided herein is a method for maintaining a biofilm formation on a plant or a part thereof comprising the step of applying a composition comprising an effective amount of a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, described herein, to a beneficial rhizobacteria. In another embodiment, the beneficial rhizobacteria is adhered to the plant or the part thereof. In another embodiment, the beneficial rhizobacteria is present in soil around the plant. In yet another embodiment, the beneficial rhizobacteria is adhered to the plant or part thereof, and is present in soil around the plant. In another embodiment, the beneficial rhizobacteria is not adhered to the plant or the part thereof. In another embodiment, the beneficial rhizobacteria is not present in soil around the plant. In another embodiment, the beneficial rhizobacteria is cultured in vitro, wherein said composition comprising an effective amount of cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, is applied to the bacteria in vitro. In another embodiment, a method for maintaining a biofilm formation on a plant or a part thereof further comprises the step of administering said beneficial rhizobacteria to said plant or part thereof, following applying a composition described herein comprising cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, to said rhizobacteria. In another embodiment, a method for maintaining a biofilm formation on a plant or a part thereof, further comprises the step of administering said beneficial rhizobacteria to soil around said plant or part thereof, following applying a composition described herein comprising a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, compound as described herein, to said rhizobacteria.

As used herein, the term “maintaining” refers in one embodiment to keeping a biofilm in existence. In another embodiment, a method of maintaining a biofilm comprises keeping the biofilm in good condition. In another embodiment, method of maintaining a biofilm comprises repairing problems in a biofilm. In another embodiment, a method of maintaining a biofilm comprises keeping a biofilm “as is” without change. In another embodiment, a method of maintaining a biofilm comprises providing nutrients to said biofilm. In another embodiment, a method of maintaining a biofilm comprises keeping beneficial rhizobacteria communities. In another embodiment, a method of maintaining a biofilm comprises attracting beneficial rhizobacteria communities to said plant or part thereof. In another embodiment, method of maintaining a biofilm comprises continued secretion of polysaccharide biopolymers from rhizobacteria. In another embodiment, a method of maintaining biofilm formation comprises inducing secretion by the rhizobacteria of polymers, for example polysaccharides EPS, or poly-6-glutamate (PGA), or any combination thereof. In another embodiment, a method of maintaining biofilm formation comprises inducing secretion by the rhizobacteria of a protein or proteins, for example TasA In another embodiment, a method of maintaining biofilm formation comprises maintaining secretion by the rhizobacteria of polymers, for example polysaccharides EPS, or poly-6-glutamate (PGA), or any combination thereof. In another embodiment, a method of maintaining biofilm formation comprises maintaining secretion by the rhizobacteria of a protein or proteins, for example TasA In another embodiment, a method of maintaining biofilm formation comprises increasing secretion by the rhizobacteria of polymers, for example polysaccharides EPS, or poly-6-glutamate (PGA), or any combination thereof. In another embodiment, a method of maintaining biofilm formation comprises increasing secretion by the rhizobacteria of a protein or proteins, for example TasA. In another embodiment, a method of maintaining a biofilm formation comprises reforming all or part of a biofilm. In another embodiment, a method of maintaining a biofilm comprises providing nutrients to the biofilm. In another embodiment, a method of maintaining a biofilm comprises removing waste compounds from a biofilm.

In another embodiment, a method of maintaining biofilm formation comprises maintaining beneficial rhizobacteria colonizing a plant root. In another embodiment, maintaining biofilm formation comprises maintaining beneficial rhizobacteria colonizing a plant root and then forming a biofilm. In another embodiment, maintaining biofilm formation comprises maintaining simultaneously beneficial rhizobacteria colonizing a plant root and formation of a biofilm. In another embodiment, a method of maintaining a biofilm comprises maintaining formation of an extracellular matrix that holds cells together. In another embodiment, the extracellular matrix comprises polysaccharide biopolymers. In another embodiment, a method of maintaining biofilm formation comprises maintaining secretion by the rhizobacteria of at least a protein, for example TasA. In another embodiment, a method of maintaining biofilm formation occurs where no biofilm is currently present. In another embodiment, a method of maintaining biofilm formation occurs at the site of an already established biofilm. In another embodiment, maintaining biofilm formation provides a beneficial effect to the plant.

In one embodiment, provided herein is a method for stimulating matrix production in a beneficial rhizobacteria for forming or maintaining a biofilm on a plant or a part thereof comprising the step of applying a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, compound described herein, to said beneficial rhizobacteria.

As used herein, the term “matrix” may be used interchangeably with the term “biofilm extracellular polymeric substances (EPS)” or “extracellular polymeric substances (EPS)” or “EPS matrix”, “biofilm matrix” or “EPS”, having all the same qualities and meanings. The EPS matrix may in one embodiment, determine the immediate conditions of life of beneficial rhizobacteria cells living in the biofilm microenvironment by affecting porosity, density, water content, charge, sorption properties, hydrophobicity, and mechanical stability. EPS are biopolymers of microbial origin, for example from the beneficial rhizobacteria, in which these biofilm rhizobacteria are embedded. In another embodiment, an EPS matrix comprises the milieu surrounding the rhizobacteria in a biofilm. Production of exopolysacchrides (EPS) or other exopolymeric material, and consequently the formation of biofilms per se, was shown to enhance bacterial survival and the potential for colonization of roots

In another embodiment, a beneficial rhizobacteria used in the methods described herein, produces the biopolymers. In another embodiment, the EPS comprises polysaccharides. In another embodiment, the EPS comprises polysaccharides, a wide variety of proteins, glycoproteins, and glycolipids, and in certain embodiment, extracellular DNA (e-DNA). In another embodiment, EPS biopolymers are highly hydrated. These hydrated EPS biopolymers form the matrix, which keeps the biofilm cells together and retains water. In another embodiment, a matrix interacts with the environment, for example, by attaching biofilms to surfaces. In another embodiment, a matrix interacts with a plant by attaching a biofilm to a surface of the plant or a part thereof.

As used herein, the term “inhibiting” or any grammatical form thereof, refers in one embodiment to inhibiting induction, enhancement or maintenance, or any combination thereof, of a biofilm and formation thereof. A skilled artisan would appreciate that the term “inhibiting” is not meant to require complete inhibition, may encompass a reduction in the induction, enhancing, and/or maintenance of a biofilm and the formation thereof. In one embodiment, reduction is by at least about 50% as compared with a control. In another embodiment, reduction is by at least about 75%. In another embodiment, reduction is by at least about 90%. In another embodiment, reduction is by at least about 95% of the induction, maintenance, or enhancement of formation of a biofilm, e.g., in the absence of a natural plant compound, as describe herein that inhibits biofilm formation.

In another embodiment, inhibition is of pellicle formation. In another embodiment, pellicle formation is reduced by 50%. In another embodiment, pellicle formation is reduced by at least 75%. In another embodiment, pellicle formation is reduced by at least 90%. In another embodiment, pellicle formation is reduced by at least 95%.

In another embodiment, a method of inhibiting biofilm formation comprises inhibiting biofilm formation by a pathogenic bacterium on a plant root. In another embodiment, a method of inhibiting pellicle formation comprises inhibiting pellicle formation of a beneficial rhizobacterium on a plant root. In another embodiment, inhibiting pellicle formation comprises beneficial rhizobacteria first colonizing a plant root and inhibition of the pellicle forming from the biofilm.

In another embodiment, a method of inhibiting biofilm formation comprises applying an effective amount of a composition comprising a natural plant compound or its metabolite, wherein said compound is selected from the group eupahakonenin B and a (E)-2-(3,7-dimethylocta-2,6-dien-1-yl)-5-pentylbenzene-1,3-diol, thereby inhibiting biofilm formation by a pathogenic bacterium on a plant root. In another embodiment, a method of inhibiting pellicle formation comprises applying an effective amount of a composition comprising a natural plant compound or its metabolite, wherein said compound is selected from the group eupahakonenin B and a (E)-2-(3,7-dimethylocta-2,6-dien-1-yl)-5-pentylbenzene-1,3-diol, thereby inhibiting pellicle formation of a beneficial rhizobacterium on a plant root. In another embodiment, inhibiting pellicle formation comprises beneficial rhizobacteria first colonizing a plant root and inhibition of the pellicle forming from the biofilm.

As used herein, the term “attaching” or any grammatical form thereof, is interchangeable with the term “adhering” or any grammatical form thereof, having all the same meanings and qualities. In another embodiment, the term “attaching” refers to an association between a biofilm and a surface of a plant or a part thereof.

In another embodiment, compositions described herein comprising a cornuside, a 2-(3,4-dihydroxyphenyl)-5-hydroxy-3,6,7-trimethoxy-4H-chromen-4-one, an isothymonin, or a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, enhance adhesion of rhizobacteria to a surface of a plant or a part thereof. In another embodiment, compositions described herein comprising a cornuside, a 2-(3,4-dihydroxyphenyl)-5-hydroxy-3,6,7-trimethoxy-4H-chromen-4-one, an isothymonin, or a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one or its derivative, isomer, tautomer, hydrate, salt, or combination thereof, enhance adhesion of B. subtilis to a surface of a plant or a part thereof. In another embodiment, compositions described herein comprising a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, compound enhance adhesion of a biofilm as described herein to a surface of a plant or a part thereof. In another embodiment, compositions described herein comprising a natural plant compound selected from the group comprising a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one or its derivative, isomer, tautomer, hydrate, salt, or combination thereof, enhance adhesion of a biofilm as described herein to a surface of a plant or a part thereof.

In another embodiment, compositions described herein comprising a eupahakonenin B or a (E)-2-(3,7-dimethylocta-2,6-dien-1-yl)-5-pentylbenzene-1,3-diol, inhibit adhesion of a pathogenic bacterium to a surface of a plant or a part thereof. In another embodiment, compositions described herein comprising a eupahakonenin B or a (E)-2-(3,7-dimethylocta-2,6-dien-1-yl)-5-pentylbenzene-1,3-diol, inhibit adhesion of a pathogenic bacterium to a surface of a biofilm on a plant or a part thereof. In another embodiment, compositions described herein comprising a eupahakonenin B or a (E)-2-(3,7-dimethylocta-2,6-dien-1-yl)-5-pentylbenzene-1,3-diol, or its derivative, isomer, tautomer, hydrate, salt, or combination thereof, inhibits adhesion of a Pseudomonas to a surface of a plant or a part thereof. In another embodiment, compositions described herein comprising a eupahakonenin B or a (E)-2-(3,7-dimethylocta-2,6-dien-1-yl)-5-pentylbenzene-1,3-diol, or its derivative, isomer, tautomer, hydrate, salt, or combination thereof, inhibits adhesion of a Pseudomonas to a surface of a biofilm on a plant or a part thereof.

In one embodiment, EPS polymers of a biofilm matrix comprise those polysaccharides whose synthesis is dependent on expression from the epsA-O operon of B. subtilis. In another embodiment, EPS polymers of a matrix comprise glucose, galactose, poly-N-acetyl glucosamine (PNAG), or levan polysaccharides, or any combination thereof.

In one embodiment, proteins of a biofilm matrix comprise those proteins expressed from the yqxM/tapA-sipW-tasA operon of B. subtilis. In another embodiment, a biofilm matrix comprises the amyloid proteins TasA, TapA or BslA, or any combination thereof.

In one embodiment, a method described herein stimulating matrix compound enhances the transcription of sinI in a beneficial rhizobacteria. In another embodiment, a method described herein stimulating matrix compound reduces transcriptional repression of an epsA-O operon or a yqxM-tapA-stPW-tasA operon, or any combination thereof, in a beneficial rhizobacteria.

In one embodiment, provided herein is a method for enhancing adhesion of a beneficial rhizobacteria to a surface of a plant or a part thereof, the method comprising the step of applying a composition comprising an effective amount of a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, compound described herein to said beneficial rhizobacteria, or to said plant or part thereof, or to a soil portion near said plant or part thereof, or any combination thereof, in an amount effective to enhance adhesion of said beneficial rhizobacteria to said plant surface or part thereof.

In another embodiment, provided herein is a method for enhancing adhesion of a beneficial rhizobacteria to a surface of a plant or a part thereof, the method comprising the step of applying a composition comprising a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one or its derivative, isomer, tautomer, hydrate, salt, or a combination thereof, to said beneficial rhizobacteria, or to said plant or part thereof, or to a soil portion near said plant or part thereof, or any combination thereof, in an amount effective to enhance adhesion of said beneficial rhizobacteria to said plant surface or part thereof.

As used herein, the term “adhesion” refers in one embodiment to an act of sticking or attaching a beneficial rhizobacteria to a plant or a part thereof. In another embodiment, adhesion comprises sticking or attaching the biofilm in which rhizobacteria communities are living to the plant or part thereof. In another embodiment, adhesion comprises sticking or attaching the biofilm matrix within which rhizobacteria communities are living to the plant or part thereof. In another embodiment, biofilms as described herein, comprise bacterial communities in which beneficial rhizobacteria communities are embedded in a matrix of extracellular polymeric compounds attached to a surface of a plant or a part thereof.

In another embodiment, adhesion of a beneficial rhizobacteria to a plant surface is reversible. In an alternative embodiment, adhesion of a beneficial rhizobacteria to a plant surface is not reversible. In another embodiment, adhesion of a beneficial rhizobacteria to a plant surface enhances productivity of the plant. In another embodiment, adhesion of a beneficial rhizobacteria to a plant surface enhances the growth of the plant. In another embodiment, adhesion of a beneficial rhizobacteria to a plant surface enhances the growth of the plant.

In another embodiment, said plant surface or plant part surface comprises an aerial surface, a root epidermis, a surface of a root hair, or a surface of transport vessels, or any combination thereof. In another embodiment, a plant surface or a surface of a plant part wherein a rhizobacteria may adhere comprises an aerial surface, for example a leaf, a flower, or a stem, or any combination thereof. In another embodiment, a plant surface or a surface of a plant part wherein a rhizobacteria may adhere comprises a root epidermis. In another embodiment, a plant surface or a surface of a plant part wherein a rhizobacteria may adhere comprises a surface of a root hair. In another embodiment, a plant surface or a surface of a plant part wherein a rhizobacteria may adhere comprises a transport vessel. For example, colonization of rhizobacteria on a plant's roots comprises adhesion of the bacteria to the root and/or root hairs. In another embodiment, rhizobacteria may adhere to multiple plant surfaces or surface of plant parts, for example to roots and root hairs.

In another embodiment, a plant surface or a surface of a plant part wherein a B. subtilis may adhere comprises an aerial surface, for example a leaf, a flower, or a stem, or any combination thereof. In another embodiment, a plant surface or a surface of a plant part wherein a B. subtilis may adhere comprises a root epidermis. In another embodiment, a plant surface or a surface of a plant part wherein a B. subtilis may adhere comprises a surface of a root hair. In another embodiment, a plant surface or a surface of a plant part wherein a B. subtilis may adhere comprises a transport vessel. For example, colonization of B. subtilis on a plant's roots comprises adhesion of the bacteria to the root and/or root hairs. In another embodiment, B. subtilis may adhere to multiple plant surfaces or surface of plant parts, for example to roots and root hairs.

In another embodiment, a plant surface or a surface of a plant part wherein a biofilm comprising a rhizobacteria may adhere comprises an aerial surface, for example a leaf, a flower, or a stem, or any combination thereof. In another embodiment, a plant surface or a surface of a plant part wherein a biofilm comprising a rhizobacteria may adhere comprises a root epidermis. In another embodiment, a plant surface or a surface of a plant part wherein a biofilm comprising a rhizobacteria may adhere comprises a surface of a root hair. In another embodiment, a plant surface or a surface of a plant part wherein a biofilm comprising a rhizobacteria may adhere comprises a transport vessel. For example, colonization of a rhizobacteria on a plant's roots comprises adhesion of the bacteria to the root and/or root hairs. In another embodiment, biofilm comprising a rhizobacteria may adhere to multiple plant surfaces or surface of plant parts, for example to roots and root hairs.

In another embodiment, a plant surface or a surface of a plant part wherein a biofilm comprising a B. subtilis may adhere comprises an aerial surface, for example a leaf, a flower, or a stem, or any combination thereof. In another embodiment, a plant surface or a surface of a plant part wherein a biofilm comprising a B. subtilis may adhere comprises a root epidermis. In another embodiment, a plant surface or a surface of a plant part wherein a biofilm comprising a B. subtilis may adhere comprises a surface of a root hair. In another embodiment, a plant surface or a surface of a plant part wherein a biofilm comprising a B. subtilis may adhere comprises a transport vessel. For example, colonization of a B. subtilis on a plant's roots comprises adhesion of the bacteria to the root and/or root hairs. In another embodiment, biofilm comprising a B. subtilis may adhere to multiple plant surfaces or surface of plant parts, for example to roots and root hairs.

In another embodiment, adhesion of a beneficial rhizobacteria with a surface of a plant or a part thereof protects plants from phytopathogens. In another embodiment, adhesion of a beneficial rhizobacteria with a surface of a plant or a part thereof protects plants from infection. In another embodiment, adhesion of a beneficial rhizobacteria with a surface of a plant or a part thereof protects an aerial part of the plant from phytopathogens. In another embodiment, adhesion of a beneficial rhizobacteria with a surface of a plant or a part thereof protects an aerial part of the plant from infection. In another embodiment, adhesion of a beneficial rhizobacteria with a surface of a plant or a part thereof protects a root of the plant from phytopathogens. In another embodiment, adhesion of a beneficial rhizobacteria with a surface of a plant or a part thereof protects a root of the plant from infection. In another embodiment, adhesion of a beneficial rhizobacteria with a surface of a plant or a part thereof protects a root hair of the plant from phytopathogens. In another embodiment, adhesion of a beneficial rhizobacteria with a surface of a plant or a part thereof protects a root hair of the plant from infection. In another embodiment, adhesion of a beneficial rhizobacteria with a surface of a plant or a part thereof protects a vasculature part of the plant from phytopathogens. In another embodiment, adhesion of a beneficial rhizobacteria with a surface of a plant or a part thereof protects a vasculature part of the plant from infection.

In another embodiment, adhesion of a B. subtilis with a surface of a plant or a part thereof protects plants from phytopathogens. In another embodiment, adhesion of a B. subtilis with a surface of a plant or a part thereof protects plants from infection. In another embodiment, adhesion of a B. subtilis with a surface of a plant or a part thereof protects an aerial part of the plant from phytopathogens. In another embodiment, adhesion of a B. subtilis with a surface of a plant or a part thereof protects an aerial part of the plant from infection. In another embodiment, adhesion of a B. subtilis with a surface of a plant or a part thereof protects a root of the plant from phytopathogens. In another embodiment, adhesion of a B. subtilis with a surface of a plant or a part thereof protects a root of the plant from infection. In another embodiment, adhesion of a B. subtilis with a surface of a plant or a part thereof protects a root hair of the plant from phytopathogens. In another embodiment, adhesion of a B. subtilis with a surface of a plant or a part thereof protects a root hair of the plant from infection. In another embodiment, adhesion of a B. subtilis with a surface of a plant or a part thereof protects a vasculature part of the plant from phytopathogens. In another embodiment, adhesion of a B. subtilis with a surface of a plant or a part thereof protects a vasculature part of the plant from infection.

In another embodiment, adhesion of a beneficial rhizobacteria with a surface of a plant or a part thereof increases pathogen resistance in the plant or in a part thereof. In another embodiment, adhesion of a beneficial rhizobacteria with a surface of a plant or a part thereof increases pathogen resistance in an aerial portion of a plant, in a root, in a root hair, or in a vasculature part of a plant, or in any combination thereof. In another embodiment, adhesion of a beneficial rhizobacteria with a surface of a plant or a part thereof increases pathogen resistance in an aerial portion of a plant. In another embodiment, adhesion of a beneficial rhizobacteria with a surface of a plant or a part thereof increases pathogen resistance in a root of a plant. In another embodiment, adhesion of a beneficial rhizobacteria with a surface of a plant or a part thereof increases pathogen resistance in a root hair of a plant. In another embodiment, adhesion of a beneficial rhizobacteria with a surface of a plant or a part thereof increases pathogen resistance in a vasculature portion of a plant.

In another embodiment, adhesion of a B. subtilis with a surface of a plant or a part thereof increases pathogen resistance in the plant or in a part thereof. In another embodiment, adhesion of a B. subtilis with a surface of a plant or a part thereof increases pathogen resistance in an aerial portion of a plant, in a root, in a root hair, or in a vasculature part of a plant, or in any combination thereof. In another embodiment, adhesion of a B. subtilis with a surface of a plant or a part thereof increases pathogen resistance in an aerial portion of a plant. In another embodiment, adhesion of a B. subtilis with a surface of a plant or a part thereof increases pathogen resistance in a root of a plant. In another embodiment, adhesion of a B. subtilis with a surface of a plant or a part thereof increases pathogen resistance in a root hair of a plant. In another embodiment, adhesion of a B. subtilis with a surface of a plant or a part thereof increases pathogen resistance in a vasculature portion of a plant.

In another embodiment, a method described herein does not induce or enhance or maintain, or any combination thereof, biofilm formation of a plant pathogen. In another embodiment, a method described herein does not stimulate biofilm matrix production of a plant pathogen. In another embodiment, a method described herein does not enhance adhesion of a plant pathogen.

Methods described herein inducing biofilm formation on a plant or part thereof, or enhancing biofilm formation on a plant or part thereof, or maintaining biofilm formation on a plant or part thereof, or enhancing adhesion of a beneficial rhizobacteria to a plant or part thereof, refer in one embodiment, to any plant or part thereof growing a soil portion. A plant may comprise any type of plant. For example, in one embodiment a plant comprises a crop plant. As used herein, the term “crop plant” refers to any plant grown for any commercial purpose, including, but not limited to the following purposes: seed production, hay production, ornamental use, fruit production, berry production, vegetable production, oil production, protein production, forage production, animal grazing, golf courses, lawns, flower production, landscaping, erosion control, green manure, improving soil tilth/health, producing pharmaceutical compounds/drugs, producing food additives, smoking compounds, pulp production and wood production. In another embodiment, a crop plant comprises a corn, a tomato, a tobacco, a cannabis, a potato or a cucumber plant.

A part of a plant may comprise any part of a plant either above ground (aerial part of a plant) or below ground. In another embodiment, an aerial part of a plant comprises leaves, twigs, blossoms, fruits or seeds, or any combination thereof. In another embodiment, below ground parts of a plant comprise roots or root hairs, or any combination thereof.

In one embodiment, pathogen resistance provided by a method described herein is systemic in a plant. In another embodiment, methods described herein increase the health and well-being of a plant. In another embodiment, methods described herein increase the yield of a plant. In another embodiment, increased yield may comprise a yield of fruits, flowers, oil, seed production, berries, vegetables, a protein compound, a forage compound, a grazing area, a golf course, a lawn, a drug compound, a botanical drug compound, a food additive, a smoking compound, a pulp compound, or any combination thereof. In another embodiment, method described herein increase size of a plant or plant part. In another embodiment, methods described herein reduce plant stress, for example reducing stress that can affect growth, survival and crop yields. In another embodiment, reduced stress on a plant reduces stress to any of stress factors selected from the group including light, temperature, water, nutrients, pollution, pathogens, or pests, or any combination thereof.

In one embodiment, pathogen resistance provided by a method described herein improves the quality of a compound produced by a plant. In another embodiment, methods described herein increase the quality of a compound comprising fruits, flowers, oil, seed production, berries, vegetables, a protein compound, a forage compound, a grazing area, a golf course, a lawn, a drug compound, a botanical drug compound, a food additive, a smoking compound, a pulp compound, or any combination thereof. Increased quality of a compound may, for example increase taste, color, texture, yield, fragrance, weight, percent of an active component, or percent protein, or any combination thereof.

In another embodiment, pathogen resistance provided by a method described herein improves the life span of a plant. In another embodiment, methods described herein increase the duration of time a plant produces a compound, where said compound comprises fruits, flowers, oil, seed production, berries, vegetables, a protein compound, a forage compound, a grazing area, a golf course, a lawn, a drug compound, a botanical drug compound, a food additive, a smoking compound, a pulp compound, or any combination thereof.

In one embodiment, methods described herein applying compositions comprising a natural plant compound or a metabolite thereof selected from the group comprising a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, a eupahakonenin B, and a (E)-2-(3,7-dimethylocta-2,6-dien-1-yl)-5-pentylbenzene-1,3-diol, as described herein, result in less use of non-natural chemical treatments for a plant or a part thereof. In another embodiment, methods described herein applying compositions comprising a natural plant compound or a metabolite thereof selected from the group comprising a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, a eupahakonenin B, and a (E)-2-(3,7-dimethylocta-2,6-dien-1-yl)-5-pentylbenzene-1,3-diol, described herein result in less use of non-natural chemical treatments for a soil portion around a plant or a plant part. In another embodiment, methods described herein provide a “green” (bio-natural) solution to providing pathogen resistance for a plant or part thereof.

In some embodiment, the term “a soil portion” refers to an area around a plant, a zone. In one embodiment, “a soil portion” refers in to the soil directly surrounding the plants roots. A zone encompasses the soil all around a plant, including below the plant. In another embodiment, a soil portion comprises the portion of soil into which the plant's roots extend or partially extend. In another embodiment, a soil portion comprises the portion of soil within about mm distance from a plant's roots. In another embodiment, a soil portion comprises the portion of soil more than 100 mm distance from a plant's roots. In another embodiment, a soil portion comprises the portion of soil within about 100 mm distance from a plant's roots. In another embodiment, a soil portion comprises the portion of soil more than about 50 mm distance from a plant's roots. In another embodiment, a soil portion comprises the portion of soil within about 50 mm distance from a plant's roots. In another embodiment, a soil portion comprises the portion of soil more than about 25 mm distance from a plant's roots. In another embodiment, a soil portion comprises the portion of soil within about 25 mm distance from a plant's roots. In another embodiment, a soil portion comprises the portion of soil more than about 10 mm distance from a plant's roots. In another embodiment, a soil portion comprises the portion of soil within about 10 mm distance from a plant's roots. In another embodiment, a soil portion comprises the portion of soil more than about 5 mm distance from a plant's roots. In another embodiment, a soil portion comprises the portion of soil within about 5 mm distance from a plant's roots. In another embodiment, a soil portion comprises the portion of soil less than 5 mm distance from a plant's roots.

In one embodiment, methods described herein apply an effective amount of a composition comprising a natural plant compound or a metabolite thereof selected from the group comprising a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one described herein to a beneficial rhizobacteria. In another embodiment, application may be directly to the beneficial rhizobacteria. In another embodiment, application may be to a soil portion around the plant on which a biofilm may form or has already formed. In another embodiment, application may be to a plant or part thereof on which a biofilm may form or has already formed. In another embodiment, the part of a plant is a root. In another embodiment, the part of a plant is a root hair. In another embodiment, the part of the plant is a root and a root hair. In another embodiment, application may be to an aerial portion of the plant on which a biofilm may form or has already formed.

In one embodiment, methods described herein apply an effective amount of a composition comprising a natural plant compound or a metabolite thereof selected from the group comprising a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, as described herein to a B. subtilis. In another embodiment, application may be directly to the B. subtilis. In another embodiment, application may be to a soil portion around the plant on which a biofilm produced by a B. subtilis, may form or has already formed. In another embodiment, application may be to a plant or part thereof on which a biofilm may form or has already formed by a B. subtilis. In another embodiment, the part of a plant is a root. In another embodiment, the part of a plant is a root hair. In another embodiment, the part of the plant is a root and a root hair. In another embodiment, application may be to an aerial portion of the plant on which a biofilm may form or has already formed.

The plant growth-promoting bacteria may frequently be found associated with plant roots where they protect plants from infection. In one embodiment, methods described herein promote plant growth.

In some embodiment, methods described herein inducing biofilm formation increases pathogen resistance in a plant or a part thereof. In some embodiment, methods described herein enhancing biofilm formation increases pathogen resistance in a plant or a part thereof. In some embodiment, methods described herein maintaining biofilm formation increases pathogen resistance in a plant or a part thereof. In some embodiment, methods described herein stimulating biofilm matrix production in a beneficial rhizobacteria increases pathogen resistance in a plant or a part thereof. In some embodiment, methods described herein enhancing adhesion of a beneficial rhizobacteria to a surface of a plant or a surface of a part thereof, increases pathogen resistance in the plant or the part thereof. In some embodiment, methods described herein stimulating biofilm matrix production in a B. subtilis increases pathogen resistance in a plant or a part thereof. In some embodiment, methods described herein enhancing adhesion of a B. subtilis to a surface of a plant or a surface of a part thereof, increases pathogen resistance in the plant or the part thereof. In another embodiment, methods described herein enhancing adhesion of a B. subtilis to a surface of a plant or a surface of a part thereof, increases pathogen resistance in a part of the plant different from the part wherein said B. subtilis adheres. In another embodiment, methods described herein enhancing adhesion of a B. subtilis to a surface of a plant or a surface of a part thereof, increases pathogen resistance in both the portion of the plant wherein said B. subtilis adheres and a part of the plant different from the part wherein said B. subtilis adheres.

In one embodiment, pathogen resistance is increased in a part of a plant on which a biofilm forms or is maintained. In another embodiment, pathogen resistance is increased in a part of a plant on which a beneficial rhizobacteria adheres. In another embodiment, pathogen resistance is increased in a part of a plant on which a B. subtilis adheres. In another embodiment, pathogen resistance is increased in a part of a plant on which a beneficial rhizobacteria colonizes. In another embodiment, pathogen resistance is increased in a part of a plant on which a B. subtilis colonizes. In another embodiment, pathogen resistance is increased in a part of a plant on which a beneficial rhizobacteria is not adherent. In another embodiment, pathogen resistance is increased in a part of a plant on which a B. subtilis is not adherent. In another embodiment, pathogen resistance is increased in an aerial part of a plant. In another embodiment, pathogen resistance is increased in a part of a plant bellow the ground. In another embodiment, pathogen resistance is increased in a root, a root hair or any combination thereof. In another embodiment, pathogen resistance is increased in a plant vasculature. In another embodiment, pathogen resistance is increased in multiple portions of a plant, comprising aerial and below ground parts of a plant in any combination thereof. In another embodiment, pathogen resistance is systemic in the plant.

In certain embodiments, plant pathogens are specific to a species or genus of plants. In one embodiment, a plant pathogen comprises a fungus or a bacterium. In another embodiment, a plant pathogen comprises a Pseudomonas or a Xanthomonas. In another embodiment, a Pseudomonas is a Pseudomonas aeruginosa PA01 or a Pseudomanas fluroescens PFZ-79. In another embodiment, a fungal pathogen is a Phytophthora infestanson.

In certain embodiments, biofilms described herein may form on aerial parts of a plant, on vasculature of a plant, or on below ground parts of a plant or any combination thereof. In one embodiment, biofilms described herein are formed on an aerial part of a plant. In another embodiment, biofilms described herein are maintained on an aerial part of a plant. In another embodiment, biofilms described herein are formed on a vasculature of a plant. In another embodiment, biofilms described herein are maintained on a vasculature of a plant. In another embodiment, biofilms described herein are formed on a root of a plant. In another embodiment, biofilms described herein are maintained on a root of a plant. In another embodiment, biofilms described herein are formed on a root hair of a plant. In another embodiment, biofilms described herein are maintained on a root hair of a plant. In another embodiment, a biofilm described herein comprises a root-associated biofilm, a root hair associated biofilm, or any combination thereof.

In certain embodiments, methods described herein comprise a step of applying a composition comprising an effective amount of a composition comprising a natural plant compound or a metabolite thereof selected from the group comprising a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, an eupahakonenin B, or a (E)-2-(3,7-dimethylocta-2,6-dien-1-yl)-5-pentylbenzene-1,3-diol, or its derivative, isomer, tautomer, hydrate, salt, or a combination thereof. In one embodiment, methods described herein comprise a step of applying a composition comprising an effective amount of a cornuside or a metabolite thereof, or its derivative, isomer, tautomer, hydrate, salt, or a combination thereof. In another embodiment, methods described herein comprise a step of applying a composition comprising an effective amount of a 2-(3,4-dihydroxyphenyl)-5-hydroxy-3,6,7-trimethoxy-4H-chromen-4-one or a metabolite thereof, or its derivative, isomer, tautomer, hydrate, salt, or a combination thereof. In another embodiment, methods described herein comprise a step of applying a composition comprising an effective amount of an isothymonin or a metabolite thereof, or its derivative, isomer, tautomer, hydrate, salt, or a combination thereof. In another embodiment, methods described herein comprise a step of applying a composition comprising an effective amount of a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one described herein or a metabolite thereof, or its derivative, isomer, tautomer, hydrate, salt, or a combination thereof. In another embodiment, methods described herein comprise a step of applying a composition comprising an effective amount of an eupahakonenin B or a metabolite thereof, or its derivative, isomer, tautomer, hydrate, salt, or a combination thereof. In another embodiment, methods described herein comprise a step of applying a composition comprising an effective amount of a (E)-2-(3,7-dimethylocta-2,6-dien-1-yl)-5-pentylbenzene-1,3-diol described herein or a metabolite thereof, or its derivative, isomer, tautomer, hydrate, salt, or a combination thereof.

In one embodiment, an effective amount is determined based on the method of application. For example, application directly to a plant or part thereof, or application to a portion around a plant, or application to a beneficial rhizobacteria such as B. subtilis, or application to a pathogenic bacteria such as Pseudomonas.

In another embodiment, an effective amount is the amount that induces biofilm formation. In another embodiment, an effective amount is the amount that enhances biofilm formation. In another embodiment, an effective amount is the amount that maintains biofilm formation. In another embodiment, an effective amount is the amount that stimulates biofilm matrix production. In another embodiment, an effective amount is the amount that enhances adhesion of a beneficial rhizobacteria. In another embodiment, an effective amount is the amount that enhances adhesion of a B. subtilis.

In another embodiment, an effective amount is the amount that inhibits induction of biofilm formation. In another embodiment, an effective amount is the amount that inhibits biofilm formation. In another embodiment, an effective amount is the amount that inhibits pellicle formation. In another embodiment, an effective amount is the amount that inhibits adhesion of pathogenic bacteria to a biofilm. In another embodiment, an effective amount is the amount that inhibits adhesion of a Pseudomonas to a biofilm.

In one embodiment, an “effective amount” of a composition comprising a natural plant compound or a metabolite thereof selected from the group comprising a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one described herein, an eupahakonenin B, or a (E)-2-(3,7-dimethylocta-2,6-dien-1-yl)-5-pentylbenzene-1,3-diol as described herein, or its derivative, isomer, tautomer, hydrate, salt, or a combination thereof for a particular result, may encompass an amount needed (or a sufficient amount) to achieve the desired goal. For example, in one embodiment an effective amount of a composition comprising a natural plant compound or a metabolite thereof selected from the group comprising a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one described herein, or its derivative, isomer, tautomer, hydrate, salt, or a combination thereof induces biofilm formation by a beneficial rhizobacteria on a plant or a part thereof. In another embodiment, an effective amount of a composition comprising a natural plant compound or a metabolite thereof selected from the group comprising a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one described herein, or its derivative, isomer, tautomer, hydrate, salt, or a combination thereof enhances biofilm formation by a beneficial rhizobacteria on a plant or a part thereof. In another embodiment, an effective amount of a composition comprising a natural plant compound or a metabolite thereof selected from the group comprising a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one described herein, or its derivative, isomer, tautomer, hydrate, salt, or a combination thereof maintains a biofilm formed by a beneficial rhizobacteria on a plant or a part thereof. In another embodiment, an effective amount of a composition comprising a natural plant compound or a metabolite thereof selected from the group comprising a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one described herein, or its derivative, isomer, tautomer, hydrate, salt, or a combination thereof stimulates matrix production by a beneficial rhizobacteria. In yet another embodiment, an effective amount of a natural plant compound or a metabolite thereof selected from the group comprising a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, described herein enhances adhesion of a beneficial rhizobacteria to a plant surface or a part thereof.

In another embodiment, an effective amount of a natural plant compound or a metabolite thereof selected from the group comprising an eupahakonenin B, or a (E)-2-(3,7-dimethylocta-2,6-dien-1-yl)-5-pentylbenzene-1,3-diol as described herein, or its derivative, isomer, tautomer, hydrate, salt, or a combination thereof, inhibits biofilm formation. In another embodiment, an effective amount of a natural plant compound or a metabolite thereof selected from the group comprising an eupahakonenin B, or a (E)-2-(3,7-dimethylocta-2,6-dien-1-yl)-5-pentylbenzene-1,3-diol as described herein, or its derivative, isomer, tautomer, hydrate, salt, or a combination thereof, inhibits pellicle formation. In another embodiment, an effective amount of a natural plant compound or a metabolite thereof selected from the group comprising an eupahakonenin B, or a (E)-2-(3,7-dimethylocta-2,6-dien-1-yl)-5-pentylbenzene-1,3-diol as described herein, or its derivative, isomer, tautomer, hydrate, salt, or a combination thereof, inhibits attachment of a plant pathogen to a biofilm. In another embodiment, an effective amount of a natural plant compound or a metabolite thereof selected from the group comprising an eupahakonenin B, or a (E)-2-(3,7-dimethylocta-2,6-dien-1-yl)-5-pentylbenzene-1,3-diol as described herein, or its derivative, isomer, tautomer, hydrate, salt, or a combination thereof, inhibits adhesion of a plant pathogen to a biofilm. In another embodiment, an effective amount of a natural plant compound or a metabolite thereof selected from the group comprising an eupahakonenin B, or a (E)-2-(3,7-dimethylocta-2,6-dien-1-yl)-5-pentylbenzene-1,3-diol as described herein, or its derivative, isomer, tautomer, hydrate, salt, or a combination thereof, inhibits attachment of a Pseudomonas to a biofilm. In another embodiment, an effective amount of a natural plant compound or a metabolite thereof selected from the group comprising an eupahakonenin B, or a (E)-2-(3,7-dimethylocta-2,6-dien-1-yl)-5-pentylbenzene-1,3-diol as described herein, or its derivative, isomer, tautomer, hydrate, salt, or a combination thereof, inhibits adhesion of a Pseudomonas to a biofilm.

In one embodiment, a composition comprising a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one described herein, an eupahakonenin B, or a (E)-2-(3,7-dimethylocta-2,6-dien-1-yl)-5-pentylbenzene-1,3-diol as described herein as described herein is applied in a dose range of about 0.1-4 ppm (0.1 μM-4 μM). In another embodiment, a composition comprising a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one described herein, an eupahakonenin B, or a (E)-2-(3,7-dimethylocta-2,6-dien-1-yl)-5-pentylbenzene-1,3-diol as described herein as described herein is applied in a dose range of about 0.5-3 ppm. In another embodiment, a composition comprising a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one described herein, an eupahakonenin B, or a (E)-2-(3,7-dimethylocta-2,6-dien-1-yl)-5-pentylbenzene-1,3-diol as described herein as described herein is applied in a dose range of about 1-2 ppm. In another embodiment, a composition comprising a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one described herein, an eupahakonenin B, or a (E)-2-(3,7-dimethylocta-2,6-dien-1-yl)-5-pentylbenzene-1,3-diol as described herein as described herein is applied in a dose of about 1 ppm. In another embodiment, a composition comprising a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one described herein, an eupahakonenin B, or a (E)-2-(3,7-dimethylocta-2,6-dien-1-yl)-5-pentylbenzene-1,3-diol as described herein described herein is applied in a dose of about 2 ppm.

In one embodiment, a composition comprising a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one described herein, an eupahakonenin B, or a (E)-2-(3,7-dimethylocta-2,6-dien-1-yl)-5-pentylbenzene-1,3-diol as described herein as described herein is applied in a dose range of about 1-500 mM. In another embodiment, a composition comprising a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one described herein, an eupahakonenin B, or a (E)-2-(3,7-dimethylocta-2,6-dien-1-yl)-5-pentylbenzene-1,3-diol as described herein as described herein is applied in a dose range of about 10-50 mM. In another embodiment, a composition comprising a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one described herein, an eupahakonenin B, or a (E)-2-(3,7-dimethylocta-2,6-dien-1-yl)-5-pentylbenzene-1,3-diol as described herein as described herein is applied in a dose of about 10 mM. In another embodiment, a composition comprising a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one described herein, an eupahakonenin B, or a (E)-2-(3,7-dimethylocta-2,6-dien-1-yl)-5-pentylbenzene-1,3-diol as described herein as described herein is applied in a dose of about 20 mM. In another embodiment, a composition comprising a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one described herein, an eupahakonenin B, or a (E)-2-(3,7-dimethylocta-2,6-dien-1-yl)-5-pentylbenzene-1,3-diol as described herein as described herein is applied in a dose of about 30 mM. In another embodiment, a composition comprising a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one described herein, an eupahakonenin B, or a (E)-2-(3,7-dimethylocta-2,6-dien-1-yl)-5-pentylbenzene-1,3-diol as described herein as described herein is applied in a dose of about 40 mM. In another embodiment, a composition comprising a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one described herein, an eupahakonenin B, or a (E)-2-(3,7-dimethylocta-2,6-dien-1-yl)-5-pentylbenzene-1,3-diol as described herein as described herein is applied in a dose of about 50 mM.

In one embodiment, the term “about”, refers to a deviance of between 0.0001-5% from the indicated number or range of numbers. In one embodiment, the term “about”, refers to a deviance of between 1-10% from the indicated number or range of numbers. In one embodiment, the term “about”, refers to a deviance of up to 25% from the indicated number or range of numbers.

In some embodiments, the term “comprise” or grammatical forms thereof, refers to the inclusion of the indicated active agent, such as a cornuside, a 2-(3,4-dihydroxyphenyl)-5-hydroxy-3,6,7-trimethoxy-4H-chromen-4-one, an isothymonin, a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one described herein, an eupahakonenin B, or a (E)-2-(3,7-dimethylocta-2,6-dien-1-yl)-5-pentylbenzene-1,3-diol as described herein as described herein, as well as inclusion of other active agents, and acceptable carriers, excipients, emollients, stabilizers, etc., as are known in the industry. In some embodiments, the term “consisting essentially of” refers to a composition, whose only active ingredient is the indicated active ingredient, however, other compounds may be included which are for stabilizing, preserving, etc. the composition, but are not involved directly in the effect of the indicated active ingredient. In some embodiments, the term “consisting essentially of” may refer to components, which exert an effect via mechanism distinct from that of the indicated active ingredient. In some embodiments, the term “consisting essentially of” may refer to components, which exert an effect and belong to a class of compounds distinct from that of the indicated active ingredient. In some embodiments, the term “consisting essentially of” may refer to components, which exert an effect and belong to a class of compounds distinct from that of the indicated active ingredient, by acting via different mechanism of action. In some embodiments, the term “consisting” refers to a composition, which contains the active ingredient and a acceptable carrier or excipient.

In one embodiment, the term “a” or “one” or “an” refers to at least one. In one embodiment the phrase “two or more” may be of any denomination, which will suit a particular purpose.

The following examples are presented in order to more fully illustrate the disclosed embodiments. They should in no way be construed, however, as limiting the broad scope of the disclosure.

### EXAMPLES

### Example 1: Screen of Natural Compounds for Promotion of Biofilm Formation

Objective:

The objective of this study was to screen natural compounds in order to evaluate their effect on promotion/induction/enhancement of Bacillus subtilis (B. subtillis) biofilm formation.

Methods:

B. subtilis, NCBI 3610 (hereafter referred to as “3610”), forms robust and highly structured biofilms in liquid medium. When inoculated into a standing culture of minimal medium, 3610 initially grows planktonically as motile, single cells. The cells then migrate to the air-liquid interface, where they proliferate as long chains of non-motile cells. These chains are highly ordered in parallel patterns and are bound together tightly, presumably by an extracellular matrix (ECM), to form a floating biofilm (pellicle). Growth of the bundled chains continues, giving rise to larger biofilm structures that include the fruiting bodies. Thus, we consider pellicles as a highly robust setting for the study of B. subtilis biofilms

Biofilm Formation Screening:

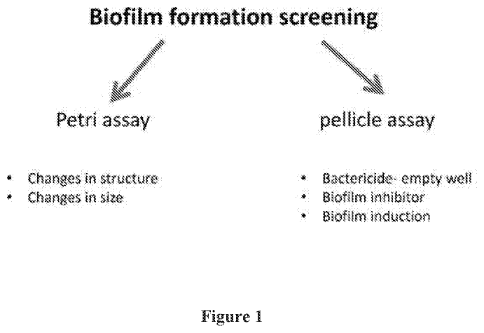

Two different assays were used to screen a natural compounds library (AnalytiCon Discovery GmbH Germany (http://www.ac-discovery.com/) for biofilm formation. A Petri Assay was used to observed changes in structure and size of biofilms, while a Pellicle Assay was used to study biofilm inhibitors and biofilm induction (FIG. 1).

The protocol for the pellicle essay comprised the following steps:

A 2× solution of rich, defined biofilm-inducing MSgg medium (Branda, S. S., Gonzalez-Pastor, J. E., Ben-Yehuda, S., Losick, R. & Kolter, R. Fruiting body formation by Bacillus subtilis. Proceedings of the National Academy of Sciences of the United States of America 98, 11621-11626, doi:10.1073/pnas.191384198 (2001)), without the calcium chloride and iron(III) chloride hexahydrate was prepared. After filter sterilization, the calcium chloride was added. The medium was ready to use directly or it could be stored at 4° C. in the dark.

A 1× dilution medium was prepared on the day of the experiment. The 2× MSgg medium was diluted to 1× with sterile distilled water (pellicles) or sterile 3% hot (80° C.) agar (biofilms) and iron(III) chloride hexahydrate added to a final concentration of 50 μM (pellicles) or 250 μM (biofilms). Molecules for screening were then added.

Compared to the original MSgg recipe (Branda, S. S., et al. (2001) ibid), the medium used contained 50 μg/ml threonine and the iron concentration to grow biofilm colonies on solid MSgg medium was increased 2.5× to optimize the wrinkled colony morphology. After solidification of the agar, dry the solid MSgg plates in a biological hood for 30-45 min prior to the inoculation.

The next step was to streak out B. subtilis from a −80° C. stock (a LB culture of 10⁹ cells/ml frozen in 20% glycerol) to isolate single colonies on a LB-1.5% agar plate with a sterile tip or applicator stick. Cultures were grown overnight at 30° C.

Following this, a single colony was picked from the LB-1.5% agar plate for growth in 3 ml LB broth at 37° C. for 4 hours in a shaking incubator (shaking speed 200 rpm) The LB broth was replaced with biofilm-inducing MSgg medium prior to inoculation by centrifuging 1 ml starter culture for 3 min at 6000 g, carefully removing the supernatant and re-suspending the pellet in 1 ml MSgg medium. The rest of the culture can be discharged.

During the growth of the starter culture, a 12-well cell-culture multidish plate containing 3 ml of MSgg medium without or with a concentration range of the small molecules (natural products to be tested) was prepared. To rule out edge effects, the location of the different concentrations was distributed across the multidish plate. Alternatively, use 24-well cell-culture multidish plates containing 1.5 ml of MSgg medium was used.

The wells of the 12-well cell-culture multidish plate were inoculated with 6 μl of the washed starter culture (1:1000 dilution). In certain embodiments, a lower dilution ratio, i.e. 1:500 could be used. This decreases the development time of the pellicles.

Grow the pellicles at 23° C. was under static conditions for three days. The pellicles were no moved during this time, as it could affect the final surface morphology of the pellicle.

Pictures of the pellicles were taken with a high resolution camera. To avoid artefacts caused by inconsistent light angles and shadows, top-down pictures were taken with the camera fixed on a stative and use a soft and large light source at 45° from both sides. Alternatively, pictures could be acquired with a binocular and homogenous exposure and lightning.

Planktonic growth, attachment to surfaces, induction of extracellular matrix genes tapA-sipW-tasA operon sinI regulator involved in biofilm formation, and biofilm development was measured and compared amongst the natural compounds identified by the screen. For the analysis for enhancement of biofilm formation and transcription of matrix genes 1 uM aqueous solutions comprising each natural compound were tested.

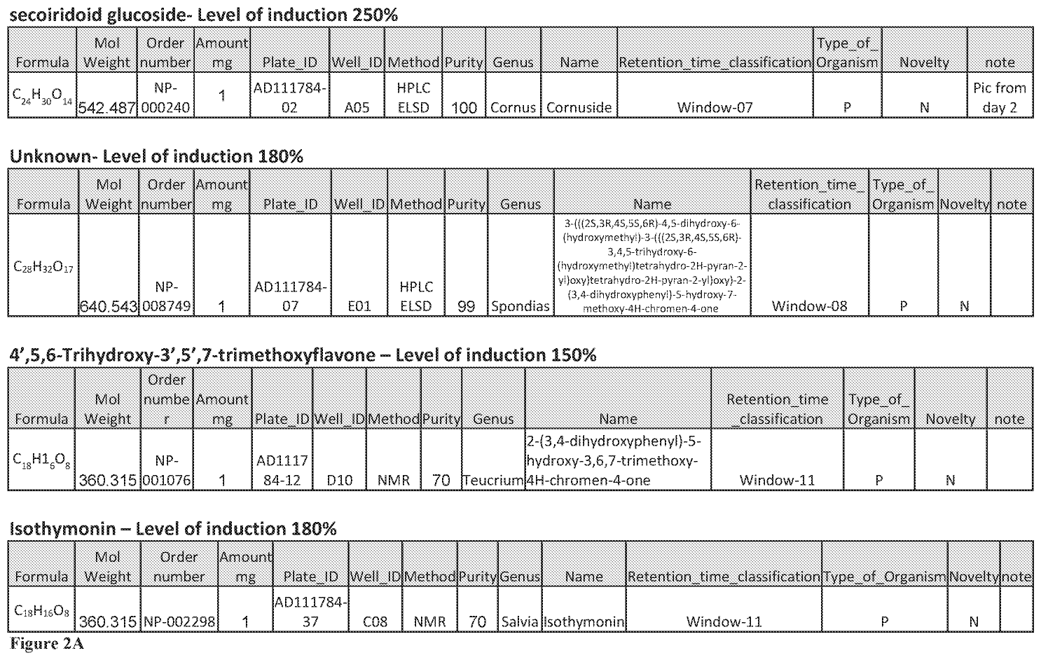

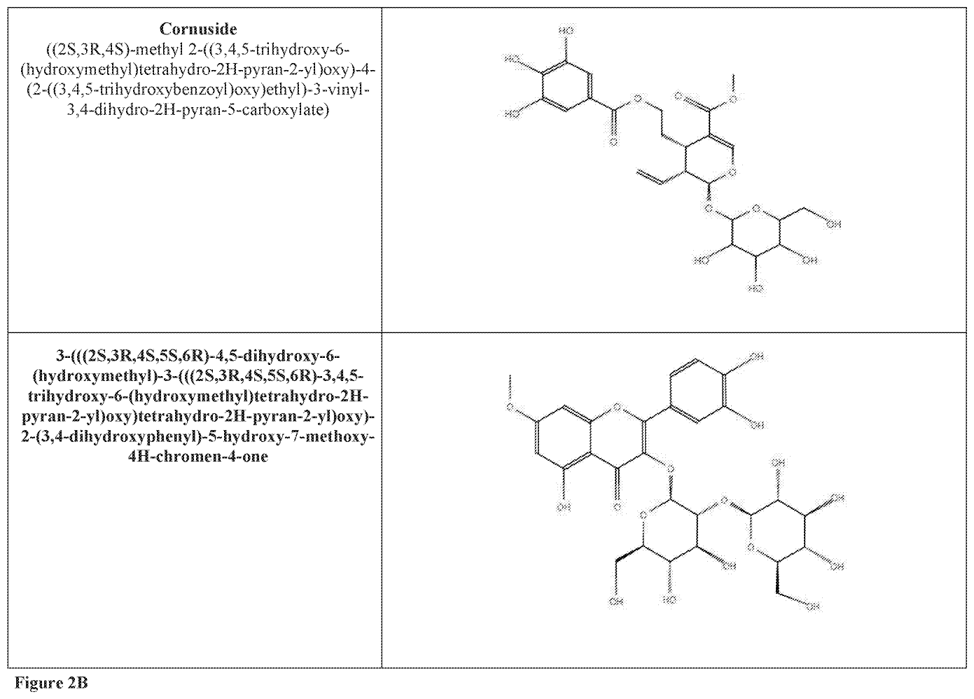

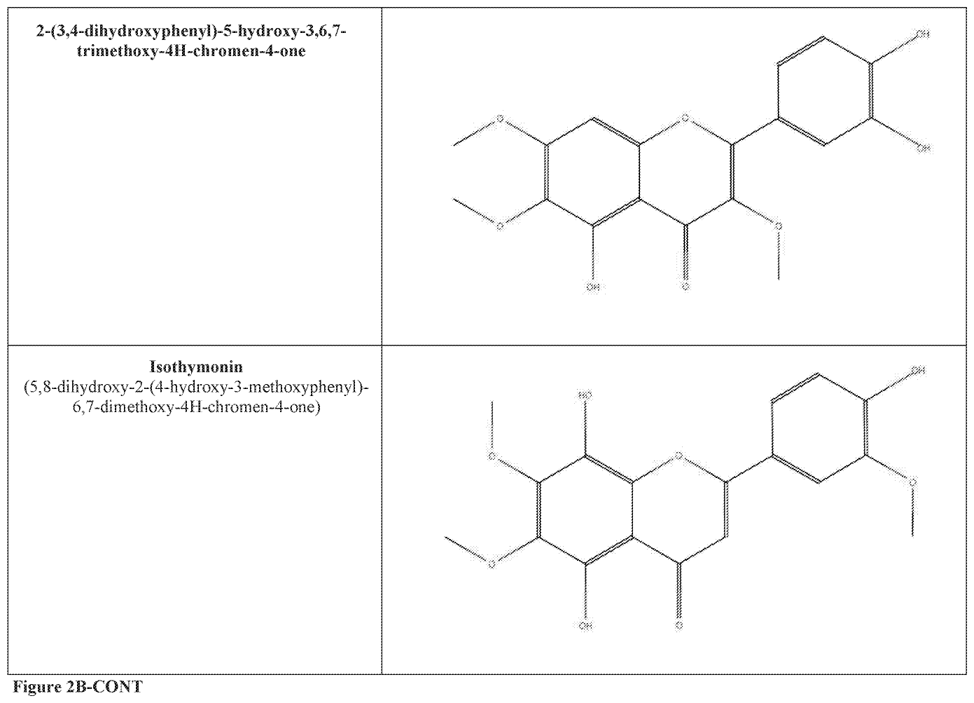

Gene expression: Gene expression was measure using reporter genes (luciferase or green fluorescent protein) Luminescence of a strains harboring sacA: P_{sinI}-luciferase was measure in the presence or absence of 1 μM of the natural compounds presented in FIGS. 2A and 2B. Fluorescence of a strain harboring sacA::PtapA-gfp was measured in presence or absence of 1 μM of the natural compounds shown in FIGS. 2A and 2B. Results are a representative of six independent experiments; the SD represents an average of 5 wells.

Results:

Using the biofilm formation screen presented in FIG. 1, several natural compounds were identified that enhance biofilm formation of the biocontrol agent B. subtilis 3610 (FIG. 2). The natural compounds identified in FIGS. 2A and 2B are plant-derived secondary metabolites. The natural compounds identified included: (1) cornuside ((2S,3R,4S)-methyl 2-((3,4,5-trihydroxy-6-(hydroxymethyl)tetrahydro-2H-pyran-2-yl)oxy)-4-(2-((3,4,5-trihydroxybenzo yl)oxy)ethyl)-3-vinyl-3,4-dihydro-2H-pyran-5-carboxylate), which is a secoiridoid glucoside with anti-inflammatory properties through the downregulation of iNOS and COX-2 via NF-kB inhibition; (2) 2-(3,4-dihydroxyphenyl)-5-hydroxy-3,6,7-trimethoxy-4H-chromen-4-one; (3) isothymonin (5,8-dihydroxy-2-(4-hydroxy-3-methoxyphenyl)-6,7-dimethoxy-4H-chromen-4-one); and (4) 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one.

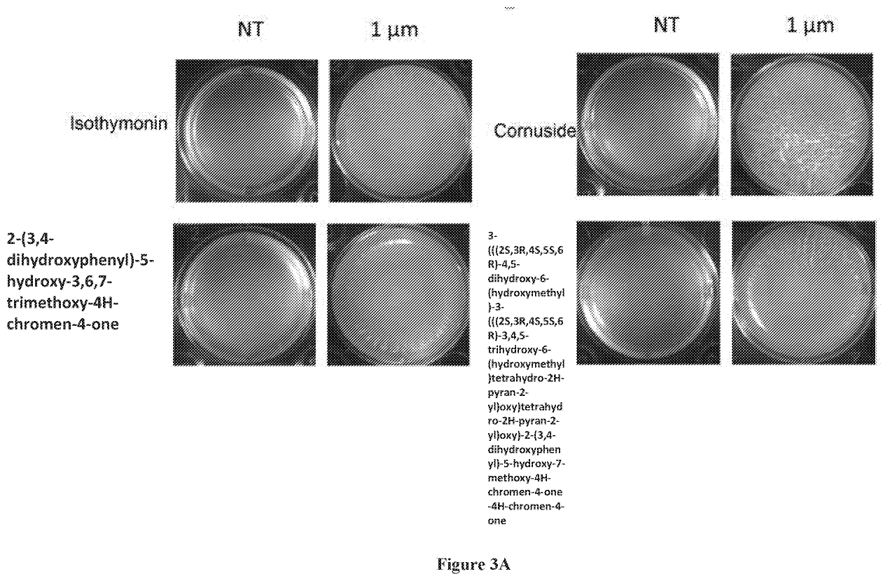

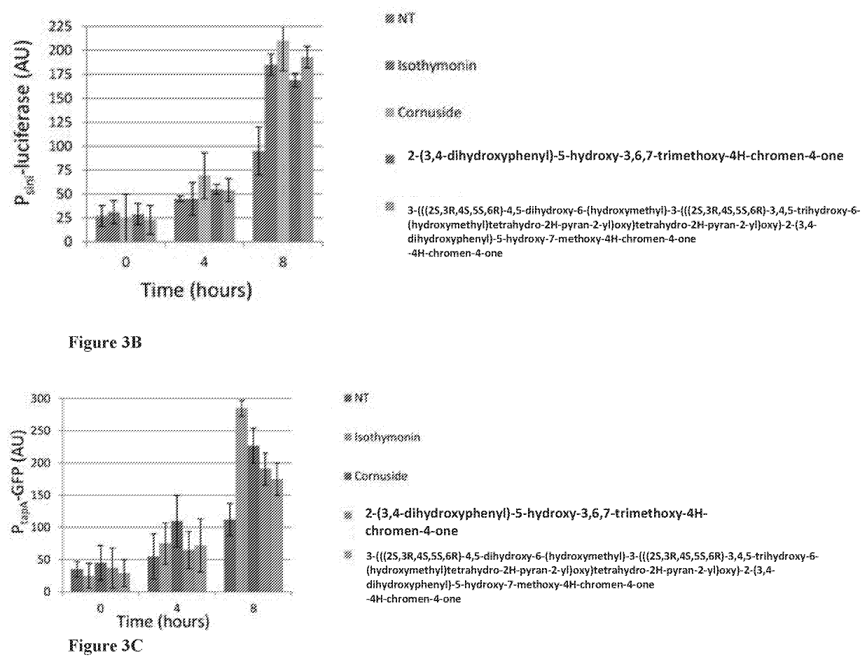

The effects of applying the natural compounds presented in FIGS. 2A and 2B to B. subtilis protective biofilms were measured. The results of measuring and comparing planktonic growth, attachment to surfaces, induction of genes involved in biofilm formation, and biofilm development indicated that the natural compounds presented in FIG. 2B specifically induce biofilm formation and biofilm gene expression in the low micromolar concentration rates, for example at least about 1 μM in the beneficial bacterium Bacillus subtilis. Analysis of solutions at concentrations above 1 μM indicated no upper limit of concentration. These natural compounds induced dramatically the biofilm of the biocontrol agent Bacillus subtilis (FIG. 3A) when used at a concentration of 1 μM. Results presented in FIG. 3A are a representative of six independent experiments. This induction may be associated with prolonged attachment to surfaces and plant roots.

The next question asked was what mechanism(s) enables biofilm induction of Bacillus subtilis by the natural compounds tested in this bacterium? The commitment to a biofilm state requires the phosphorylation of the master regulator Spo0A. Spo0A-P activates SinI, which represses SinR via direct binding. SinR is the main transcriptional repressor of two matrix encoding operons, epsA-O operon, and the tapA-sipW-tasA operon, encoding the amyloid protein TasA, the major protein component of the biofilm matrix.

The expression of SinI, the matrix regulator, was measured as was the expression of tapA-sipW-tasA operon, in the absence and presence of the natural compounds listed in FIG. 2B. Specifically, sinI transcription was monitored. SinI transcription is a direct readout for the activity of the genetic pathway resulting in matrix production and biofilm formation. sinI transcription in biofilm-inducing medium was monitored using the sinI promoter fused to luciferase.

The biofilm inducing concentration of 1 μM of each of cornuside, dihydroxyphenyl)-5-hydroxy-3,6,7-trimethoxy-4H-chromen-4-one, isothymonin, and 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, significantly enhanced the transcription of sinI (FIG. 3B). Importantly, as the sinI pathway is only conserved among Bacillus subtilis species, it is another indication to the quite specific activity of these natural compounds on B. subtilis beneficial communities. The results further confirmed that the matrix was indeed being induced by these natural compounds, as shown by measuring the transcription of tapA-sipW-tasA (FIG. 3C).

Conclusion: The natural compounds cornuside, 2-(3,4-dihydroxyphenyl)-5-hydroxy-3,6,7-trimethoxy-4H-chromen-4-one, isothymonin, and 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-yl)oxy)-2-(3,4-dihydroxyphenyl)-5-hydroxy-7-methoxy-4H-chromen-4-one, promoted, induced, and enhanced biofilm formation of B. subtilis and, as well, enhance transcription expression of matrix genes in the beneficial bacterium B. subtilis. These results indicated that these natural compounds specifically induce biofilm formation and biofilm genes at a low micromolar concentration (˜1 μM) in the beneficial bacterium Bacillus subtilis. This induction of biofilm formation and biofilm genes may be associated with prolonged attachment to surfaces and plant roots.

### Example 2: Screen of Natural Compounds for Inhibition of Biofilm Formation

Bacillus subtilis forms robust and highly structured biofilms both in liquid (pellicles) and on solid medium (colonies). Hence, it serves as an ideal model organism to characterize the mode of action of specific biofilm inhibitors. Several approaches were used previously to study biofilm assembly and development with B. subtilis as a model organism. Bacterial biofilms are of crucial significance in agricultural, industrial and clinical settings. In an agricultural context, the capacity to form biofilms increases the plant host colonization of numerous plant pathogens, and in a clinical context, biofilms are inherently resistant to antimicrobial agents and are at the core of many persistent and chronic bacterial infections. In addition, it is now acknowledged that biofilms have huge cost implications to industry as they are extremely difficult to remove and control. Thus, developing an experimental framework for the study of microbial biofilm inhibitors will provide significant agricultural and technological advancements.

Objective: The objective of this study was to screen natural compounds in order to evaluate their effect on inhibition of Bacillus subtilis (B. subtillis) biofilm formation.

Methods:

Biofilm Screening for Inhibitors:

Similar to Example 1, a Pellicle Assay was used to study biofilm inhibitors (FIG. 1). Analysis of submerged biofilm formation by P. sytingae pv tomato included staining attached cells with crystal violet and quantified as known in the art (Mol Microbiology 28:449-461).

Results:

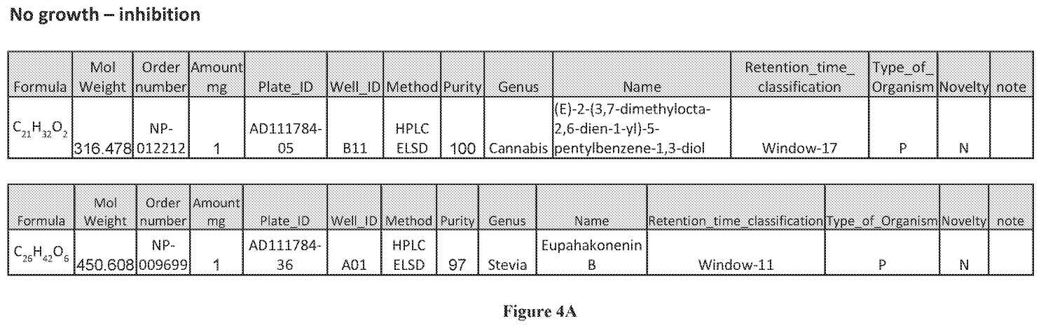

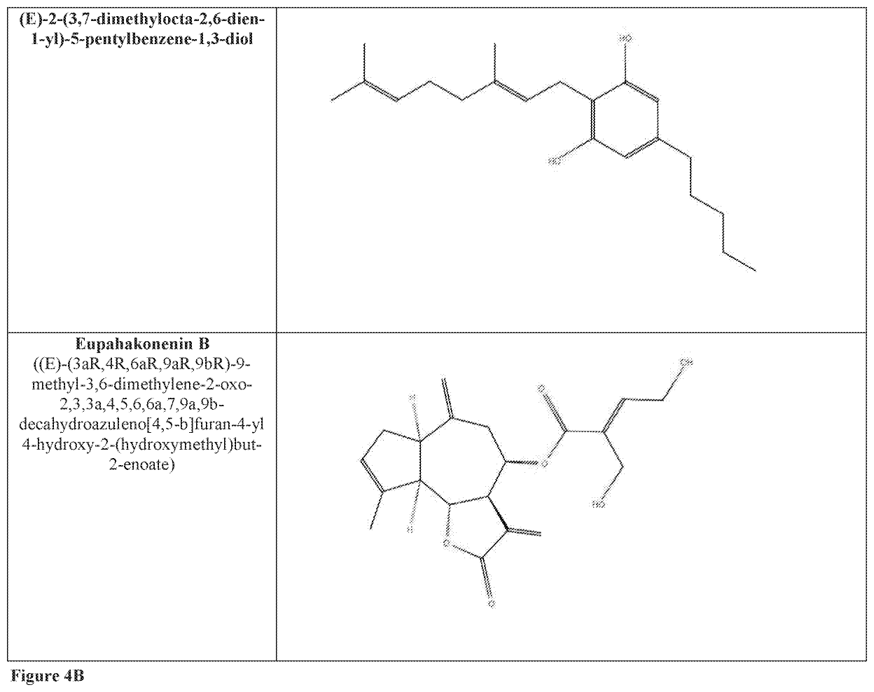

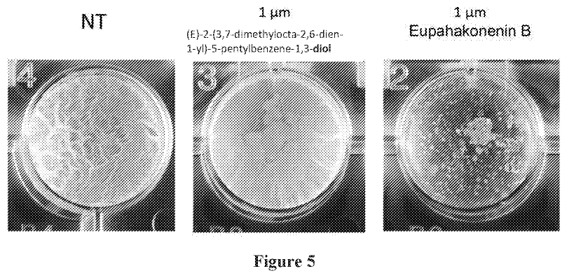

In our screen (FIG. 1), two biofilm inhibitors were found: a (E)-2-(3,7-dimethylocta-2,6-dien-1-yl)-5-pentylbenzene-1,3-diol and the guaianolide eupahakonenin B (FIGS. 4A and 4B). These inhibitors blocked pellicle formation of the model organism B. subtilis in concentrations (1 μM) inert to planktonic growth (FIG. 5).

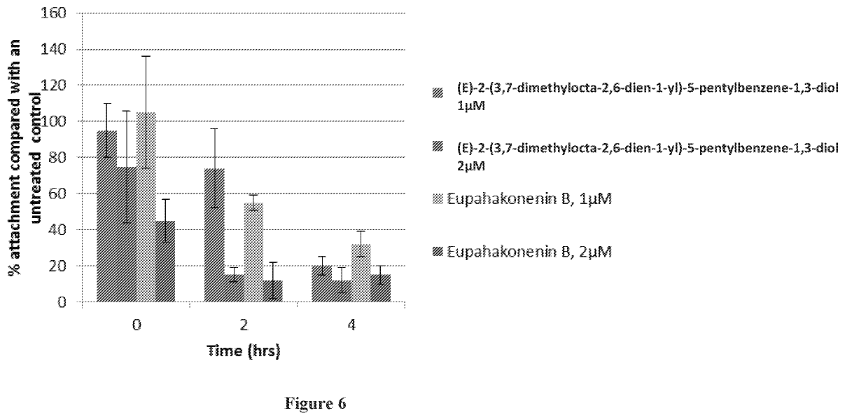

As B. subtilis is a beneficial bacterium, the effects of the biofilm inhibitors presented in FIGS. 4A and 4B, on pseudomonas species typically belonging to a family of plant pathogens was also characterized. As shown (FIG. 6), biofilm formation in a plant pathogen P. sytingae pv tomato, was reduced significantly in the presence of these two biofilm inhibitors. The natural compound from Cannabis, (E)-2-(3,7-dimethylocta-2,6-dien-1-yl)-5-pentylbenzene-1,3-diol), was especially promising as it mildly inhibited the beneficial bacterium (B. subtilis see FIG. 5), but strongly inhibited attachment in the plant pathogen P. sytingae pv tomato (FIG. 6).

While certain features have been illustrated and described herein, many modifications, substitutions, changes, and equivalents will now occur to those of ordinary skill in the art. It is, therefore, to be understood that the appended claims are intended to cover all such modifications and changes as fall within the true spirit of this disclosure.

1. A method for inducing biofilm formation, enhancing biofilm formation stimulating matrix production by a beneficial rhizobacteria, or enhancing transcription of matrix genes in a beneficial rhizobacteria, said method comprising the step of applying an effective amount of a composition comprising a natural plant compound or a metabolite thereof to the beneficial rhizobacteria, wherein said natural plant compound or a metabolite thereof is selected from the group comprising cornuside, 2-(3,4-dihydroxyphenyl)-5-hydroxy-3,6,7-trimethoxy-4H-chromen-4-one, isothymonin, and a 3-(((2S,3R,4S,5S,6R)-4,5-dihydroxy-6-(hydroxymethyl)-3-(((2S,3R,4S,5S,6R)-3,4,5-trihydroxy-6-(hydroxymethyl)tetrahydro-2H-pyran-2-yl)oxy)tetrahydro-2H-pyran-2-0)oxy)-2-(3,4-dihydroxyphenyl)-5-hydroxy-7-methoxy-4H-chromen-4-one.

2. (canceled)

3. (canceled)

4. (canceled)

5. The method of claim 1, wherein said natural plant compound is its derivative, isomer, tautomer, hydrate, salt, or a combination thereof.

6. The method of claim 1, wherein said biofilm formation is on a plant or a plant part.

7. The method of claim 6, wherein said plant or plant part comprises a plant root or part thereof.

8. The method of claim 1, wherein said method increases pathogen resistance in a plant or a part thereof.

9. The method according to claim 8, wherein said pathogen comprises a fungus or a bacterium.

10. The method of claim 1, wherein said beneficial rhizobacteria comprises a Bacillus subtilis (B. subtilis) species.

11. The method of claim 10, wherein said B. subtilis is selected from the group comprising B. subtilis NCBI 3610, B. subtilis FB17, B. subtilis NATTO, B. subtilis CPA-8, B. subtilis RO-FF-1, B. subtilis JH642, B. subtilis GB03, B. subtilis E1R-J, and B. subtilis FZB37.

12. The method of claim 1, wherein said composition comprises a plant extract.

13. The method of claim 1, wherein said composition comprises a combination of said natural plant compound or metabolite thereof, and any other active compound from the same plant source as the natural plant compound.

14. The method of claim 1, wherein said natural compound is purified from a plant.

15. The method of claim 1, wherein said natural compound comprises a semi-synthetic or a synthetic variant.

16. The method of claim 1, wherein said composition is applied directly to the beneficial rhizobacteria spores or to a biofilm formed by a beneficial rhizobacteria.

17. (canceled)

18. The method of claim 16, wherein said applying further comprises applying said composition to spores of said rhizobacteria prior to, concurrent with, or following application of said natural compound to the biofilm formed by said beneficial rhizobacteria.

19. The method of claim 16, wherein said apply comprises applying said natural compound or a metabolite thereof at a dose of at least about 1 μM.

20. The method of claim 1, wherein said composition comprises said natural compound at a concentration of at least about 1 uM.

21. The method of claim 1, wherein said matrix genes comprise sinI or tapA, or a combination thereof.

22. The method of claim 1, wherein said composition comprises a solution, a powder, a spray, drops, a tablet, or a paste.

23.

24. A method for inhibiting biofilm formation, pellicle formation, by a plant pathogen, or inhibiting attachment of a plant pathogen to a biofilm, said method comprising the step of applying an effective amount of a composition comprising a natural plant compound or a metabolite thereof to the plant pathogen, wherein said natural plant compound or a metabolite thereof is selected from the group comprising a (E)-2-(3,7-dimethylocta-2,6-dien-1-yl)-5-pentylbenzene-1,3-diol and a eupahakonenin B compound.

25. (canceled)

26. (canceled)

27. The method of claim 24, wherein said natural plant compound or a metabolite thereof is its derivative, isomer, tautomer, hydrate, salt, or a combination thereof.

28. The method of claim 24, wherein said biofilm formation or said pellicle formation inhibited on a plant or a plant part, or said attachment is inhibited to a biofilm attached to a plant or a plant part.

29. The method of claim 28, wherein said plant or plant part comprises a root or a part thereof.

30. The method according to claim 24, wherein said pathogen comprises a fungus or a bacterium.

31. The method of claim 24, wherein said plant pathogen comprises a pseudomonas species.

32. The method of claim 31, wherein said pseudomonas species is selected from the group comprising P. sytingae pv tomato.

33. The method of claim 24, wherein said composition comprises a plant extract.

34. The method of claim 24, wherein said composition comprises a combination of said natural plant compound or metabolite thereof, and any other active compound from the same plant source as the natural plant compound.

35. The method of claim 24, wherein said natural compound is purified from a plant.

36. The method of claim 24, wherein said natural compound comprises a semi-synthetic or a synthetic variant.

37. The method of claim 24, wherein said composition is applied to a biofilm or to a plant surface or a portion thereof.

38. (canceled)

39. The method of claim 24, wherein said applying comprises applying said natural compound or a metabolite thereof at a dose of at least about 1-2 μM.

40. The method of claim 24, wherein said composition comprises said natural compound or a metabolite thereof at a concentration of about 1-2 μM.

41. The method of claim 24, wherein said composition comprises a solution, a powder, a spray, drops, a tablet, or a paste.

42. The method of claim 41, wherein said solution or said spray comprise an aqueous solution or an aqueous spray.

43. The method of claim 24, wherein said natural compound inhibits formation of a beneficial rhizobacteria biofilin to a lesser extent than the inhibition of said plant pathogen biofilm.

44. The method of claim 43, wherein said beneficial rhizobacteria comprises a Bacillus subtilis (B. subtilis) species.

45. The method of claim 44, wherein said B. subtilis is selected from the group comprising B. subtilis NCBI 3610, B. subtilis FB17, B. subtilis NATTO, B. subtilis CPA-8, B. subtilis RO-FF-1, B. subtilis JH642, B. subtilis GB03, B. subtilis E1R-J, and B. subtilis FZB37.
